(19) United States
(12) Patent Application Publication
(10) Pub. No.: US 2011/0014982 A1
(43) Pub. Date: Jan. 20, 2011

(54) POSITION DETECTION SYSTEM, POSITION DETECTION METHOD, INFORMATION STORAGE MEDIUM, AND IMAGE GENERATION DEVICE

(75) Inventor: Hiroyuki HIRAISHI, Yokohama-shi (JP)

Correspondence Address: OLIFF & BERRIDGE, PLC, P.O. BOX 320850, ALEXANDRIA, VA, 22320-4850, US

(73) Assignee: NAMCO BANDAI GAMES INC., Tokyo (JP)

(21) Appl. No.: 12/893,424

(22) Filed: Sep. 29, 2010

Related U.S. Application Data
(63) Continuation of application No. PCT/JP2009/056487, filed on Mar. 30, 2009.

(30) Foreign Application Priority Data
Mar. 31, 2008 (JP) 2008-093518

(51) Int. Cl. A63F 13/04; H04N 7/18; G09G 5/377

(52) U.S. Cl. 463/36; 348/135; 345/641

(57) ABSTRACT

A position detection system includes an image acquisition section that acquires an image from an imaging device when the imaging device has acquired an image of an imaging area corresponding to a pointing position from a display image generated by embedding a marker image as a position detection pattern in an original image, and a position detection section that performs a calculation process that detects the marker image embedded in the acquired image based on the acquired image to determine the pointing position corresponding to the imaging area.

### CROSS REFERENCE TO RELATED APPLICATION

This application is a continuation of International Patent Application No. PCT/JP2009/056487, having an international filing date of Mar. 30, 2009, which designated the United States, the entirety of which is incorporated herein by reference. Japanese Patent Application No. 2008-093518 filed on Mar. 31, 2008 is also incorporated herein by reference in its entirety.

### BACKGROUND

The present invention relates to a position detection system, a position detection method, an information storage medium, an image generation device, and the like.

A gun game that allows the player to enjoy shooting a target object displayed on a screen using a gun-type controller has been popular. When the player (operator) has pulled the trigger of the gun-type controller, the shot impact position (pointing position) is optically detected utilizing an optical sensor provided in the gun-type controller. It is determined that the target object has been hit when the target object is present at the detected impact position, and it is determined that the target object has not been hit when the target object is not present at the detected impact position. The player can virtually experience shooting by playing the gun game,

JP-A-8-226793 and JP-A-11-319316 disclose a related-art position detection system used for such a gun game.

In JP-A-8-226793, at least one target is provided around the display screen. The position of the target is detected from the acquired image, and the impact position of the gun-type controller is detected based on the detected position of the target. In JP-A-11-319316, the frame of the monitor screen is displayed, and the impact position of the gun-type controller is detected based on the detected position of the frame.

According to these related-art technologies, however, since the impact position is detected based on the position of the target or the frame, the detection accuracy decreases. Moreover, a calibration process for specifying the position of the target is required as the initial setting before starting the game. This process is troublesome for the player.

Digital watermarking technology that embeds secret data in an image has been known. However, position detection data has not been embedded by digital watermarking technology, and digital watermarking technology has not been applied to a position detection system for a gun game or the like.

### SUMMARY

According to one aspect of the invention, there is provided a position detection system that detects a pointing position, the position detection system comprising:

an image acquisition section that acquires an image from an imaging device when the imaging device has acquired an image of an imaging area corresponding to the pointing position from a display image, the display image being generated by embedding a marker image as a position detection pattern in an original image; and

a position detection section that performs a calculation process that detects the marker image embedded in the acquired image based on the acquired image to determine the pointing position corresponding to the imaging area.

According to another aspect of the invention, there is provided a position detection method comprising:

generating a display image by embedding a marker image as a position detection pattern in an original image, and outputting the generated display image to a display section;

detecting the marker image embedded in an image acquired from the display image based on the acquired image;

determining a pointing position corresponding to an imaging area of the acquired image; and

performing a calculation process based on the determined pointing position.

According to another aspect of the invention, there is provided a computer-readable information storage medium storing a program that causes a computer to implement the above position detection method.

According to another aspect of the invention, there is provided an image generation device comprising:

an image generation section that generates a display image by embedding a marker image as a position detection pattern in an original image, and outputs the generated display image to a display section; and

a processing section that performs a calculation process based on a pointing position when the marker image embedded in an image acquired from the display image has been detected based on the acquired image and the pointing position corresponding to an imaging area of the acquired image has been determined.

### BRIEF DESCRIPTION OF THE DRAWINGS

FIG. 1 shows a configuration example of a position detection system according to one embodiment of the invention.

FIG. 2 is a view illustrative of a method of according to a first comparative example.

FIGS. 3A and 3B are views illustrative of a method of according to a second comparative example.

FIG. 4 is a view illustrative of a method of embedding a marker image in an original image.

FIG. 5 is a view illustrative of a position detection method according to one embodiment of the invention.

FIGS. 6A and 6B are views illustrative of a marker image according to one embodiment of the invention.

FIG. 7 shows a data example of an M-array used in connection with one embodiment of the invention.

FIG. 8 shows a data example of an original image.

FIG. 9 shows a data example of a display image generated by embedding a marker image in an original image.

FIG. 10 shows a data example of an acquired image.

FIG. 11 shows an example of cross-correlation values obtained by a cross-correlation calculation process on an acquired image and a marker image.

FIG. 12 is a flowchart showing a marker image embedding process.

FIG. 13 is a flowchart showing a position detection process.

FIG. 14 is a flowchart showing a cross-correlation calculation process.

FIG. 15 is a flowchart showing a reliability calculation process.

FIG. 16 is a view illustrative of reliability,

FIG. 17 shows a configuration example of an image generation device and a gun-type controller according to one embodiment of the invention.

FIGS. 18A and 18B are views illustrative of a marker image change process.

FIG. 19 shows a data example of a second M-array.

FIG. 20 is a view showing a marker image generated using a first M-array.

FIG. 21 is a view showing a marker image generated using a second M-array.

FIGS. 22A and 22B show application examples of marker images that differ in depth.

FIGS. 23A and 23B are views illustrative of a marker image change method.

FIGS. 24A and 24B are views illustrative of a method that displays an image generated by embedding a marker image when a given condition has been satisfied.

FIG. 25 is a flowchart showing a process of an image generation device.

### DESCRIPTION OF EXEMPLARY EMBODIMENTS

Several aspects of the invention may provide a position detection system, a position detection method, an information storage medium, an image generation device, and the like that can detect a pointing position with high accuracy.

According to one embodiment of the invention, there is provided a position detection system that detects a pointing position, the position detection system comprising:

an image acquisition section that acquires an image from an imaging device when the imaging device has acquired an image of an imaging area corresponding to the pointing position from a display image, the display image being generated by embedding a marker image as a position detection pattern in an original image; and

a position detection section that performs a calculation process that detects the marker image embedded in the acquired image based on the acquired image to determine the pointing position corresponding to the imaging area.

According to this embodiment, an image is acquired from the imaging device when the imaging device has acquired an image from the display image generated by embedding the marker image in the original image. The calculation process that detects the marker image is performed based on the acquired image to determine the pointing position corresponding to the imaging area. According to this configuration, since the pointing position is detected by detecting the marker image embedded in the acquired image, the pointing position can be detected with high accuracy.

In the position detection system,

the display image may be generated by converting each pixel data of the original image using each pixel data of the marker image.

According to this configuration, the marker image can be embedded while maintaining the appearance (state) of the original image.

In the position detection system,

the display image may be generated by converting at least one of R component data, G component data, B component data, color difference component data, and brightness component data of each pixel of the original image using each pixel data of the marker image.

According to this configuration, the data of the marker image can be embedded in the R component data, G component data, B component data, color difference component data, or brightness component data of each pixel of the original image.

In the position detection system,

the marker image including pixel data may have a unique data pattern in each segmented area of the display image.

According to this configuration, the pointing position can be specified by utilizing the data pattern of the marker image that is unique in each segmented area.

In the position detection system,

each pixel data of the marker image may be generated by random number data using a maximal-length sequence.

According to this configuration, the unique data pattern of the marker image can be generated by a simple method.

In the position detection system,

the imaging device may acquire an image of the imaging area that is smaller than a display area of the display image.

This makes it possible to relatively increase the resolution as compared with the case of acquiring an image of a large area, even if the number of pixels of the imaging device is small, so that the pointing position detection accuracy can be improved.

In the position detection system,

the position detection section may calculate a cross-correlation between the acquired image and the marker image, and may determine the pointing position based on the cross-correlation calculation results.

According to this configuration, the pointing position can be detected with high accuracy by performing the cross-correlation calculation process on the acquired image and the marker image.

In the position detection system,

the position detection section may perform a high-pass filter process on the cross-correlation calculation results or the marker image.

This makes it possible to reduce the power of noise due to the original image, so that the detection accuracy can be improved.

The position detection system may further comprise:

a reliability calculation section that calculates the reliability of the cross-correlation calculation results based on a maximum cross-correlation value and a distribution of cross-correlation values.

This makes it possible to implement various processes utilizing the determined reliability.

The position detection system may further comprise:

an image correction section that performs an image correction process on the acquired image,

the position detection section may determine the pointing position based on the acquired image that has been subjected to the image correction process by the image correction section.

This makes it possible to implement an appropriate position detection process even if the positional relationship with the imaging device has changed, for example.

According to another embodiment of the invention, there is provided a position detection method comprising:

generating a display image by embedding a marker image as a position detection pattern in an original image, and outputting the generated display image to a display section;

detecting the marker image embedded in an image acquired from the display image based on the acquired image;

determining a pointing position corresponding to an imaging area of the acquired image; and

performing a calculation process based on the determined pointing position.

According to another embodiment of the invention, there is provided a computer-readable information storage medium storing a program that causes a computer to implement the above position detection method.

According to this embodiment, the display image is generated by embedding the marker image in the original image, and displayed on the display section. When the marker image has been detected based on the acquired image acquired from the display image, and the pointing position has been determined, various calculation processes are performed based on the determined pointing position. Since the pointing position is detected by detecting the marker image embedded in the acquired image, the pointing position can be detected with high accuracy, and utilized for various calculation processes.

The position detection method may further comprise:

performing a game process including a game result calculation process based on the pointing position.

This makes it possible to implement the game process (e.g., game result calculation process) utilizing the pointing position that has been determined with high accuracy.

The position detection method may further comprise:

generating the display image by converting each pixel data of the original image using each pixel data of the marker image.

The position detection method may further comprise:

generating the display image by converting at least one of R component data, G component data, B component data, color difference component data, and brightness component data of each pixel of the original image using each pixel data of the marker image.

In the position detection method,

the marker image including pixel data may have a unique data pattern in each segmented area of the display image.

In the position detection method,

each pixel data of the marker image may be generated by random number data using a maximal-length sequence.

The position detection method may further comprise:

changing the marker image with a lapse of time.

This makes it possible to increase the total amount of information included in the marker images, so that the detection accuracy can be improved.

The position detection method may further comprise:

calculating a cross-correlation between the acquired image and the marker image in order to determine the pointing position; and

determining the reliability of the cross-correlation calculation results, and changing the marker image based on the determined reliability.

According to this configuration, since the marker image with high position detection reliability is embedded in the original image, the detection accuracy can be improved.

The position detection method may further comprise:

changing the marker image corresponding to the original image.

This makes it possible to embed a marker image appropriate for the appearance (state) of the original image.

The position detection method may further comprise:

acquiring disturbance measurement information; and

changing the marker image based on the disturbance measurement information.

According to this configuration, since an optimum marker image can be embedded based on the disturbance measurement information, an appropriate position detection process can be implemented.

The position detection method may further comprise:

outputting the original image in which the marker image is not embedded as the display image when a given condition has not been satisfied; and

outputting an image generated by embedding the marker image in the original image as the display image when the given condition has been satisfied.

According to this configuration, since an image generated by embedding the marker image in the original image is displayed only when the given condition has been satisfied, the marker image can be rendered inconspicuous so that the quality of the display image can be improved.

The position detection method may further comprise:

generating a position detection original image as the original image when the given condition has been satisfied; and

outputting an image generated by embedding the marker image in the position detection original image as the display image.

This makes it possible to implement an effect utilizing the position detection original image,

The position detection method may further comprise:

outputting an image generated by embedding the marker image in the original image as the display image when it has been determined that a position detection timing has been reached based on instruction information from a pointing device.

According to this configuration, since an image generated by embedding the marker image in the original image is displayed when the position detection timing has been reached based on the instruction information from the pointing device, the marker image can be rendered inconspicuous so that the quality of the display image can be improved.

The position detection method may further comprise:

performing a game process including a game result calculation process based on the pointing position; and

outputting an image generated by embedding the marker image in the original image as the display image when a given game event has occurred during the game process.

According to this configuration, since an image generated by embedding the marker image in the original image is displayed when a given game event has occurred, the marker image can be embedded corresponding to the game event.

The position detection method may further comprise:

determining the pointing position based on the acquired image acquired from the display image when a given condition has been satisfied.

According to this configuration, an image generated by embedding the marker image in the original image may be necessarily displayed irrespective of whether or not the given condition has been satisfied, and the pointing position may be determined by acquiring an acquired image acquired from the display image when the given condition has been satisfied. For example, it may be determined that the given condition has been satisfied when it has been determined that the position detection timing has been reached based on instruction information from the pointing device, or a given game event has occurred during the game process, and the pointing position may be determined using the acquired image acquired at the timing at which the given condition has been satisfied.

Embodiments of the invention are described below. Note that the following embodiments do not in any way limit the scope of the invention laid out in the claims. Note also that all elements of the following embodiments should not necessarily be taken as essential requirements for the invention.

1. Position Detection System

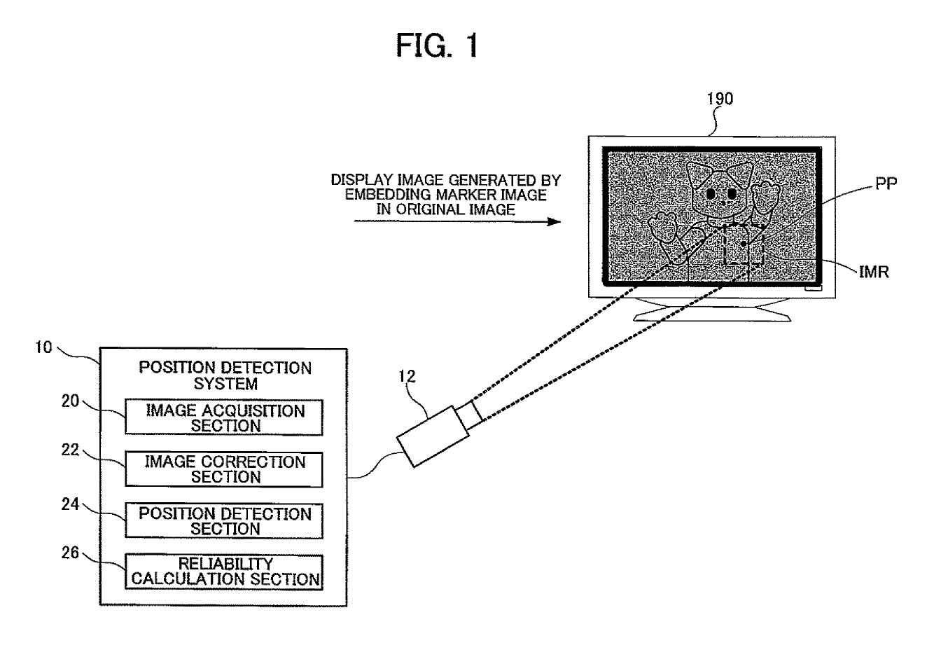

FIG. 1 shows a configuration example of a position detection system according to one embodiment of the invention. In FIG. 1, a display image generated by embedding a marker image is displayed on a display section 190 (e.g., CRT or LCD). For example, the display image is generated by embedding the marker image (i.e., position detection image or digitally watermarked image) that is a position detection pattern in an original image (e.g., game image) (i.e., an image that displays an object (e.g., game character) or background image), and displayed on the display section 190. Specifically, the display image is generated by converting each pixel data (RGB data or YUV data) of the original image using each pixel data (data corresponding to each pixel of the original image) of the marker image. More specifically, the display image is generated by converting at least one of R component data, G component data, B component data, color difference component data, and brightness component data of each pixel of the original image using each pixel data (e.g., M-array) of the marker image. In this case, the marker image includes pixel data having a unique data pattern in each segmented area (i.e., each area that includes a plurality of rows and a plurality of columns of pixels) of the display image (display screen), for example. Specifically, the position detection pattern of the marker image differs between an arbitrary first segmented area and an arbitrary second segmented area of the display image. Each pixel data of the marker image may be generated by random number data (pseudo-random number data) using a maximal-length sequence, for example.

The position detection system 10 includes an image acquisition section 20, an image correction section 22, a position detection section 24, and a reliability calculation section 26. Note that the position detection system 10 according to this embodiment is not limited to the configuration shown in FIG. 1. Various modifications may be made, such as omitting some (e.g., image correction section and reliability calculation section) of the elements or adding other elements (e.g., image synthesis section). For example, the position detection system 10 may have a function (synthesis function) of embedding the marker image in the original image (e.g., game image) generated by an image generation device described later.

The image acquisition section 20 acquires an image (acquired image) acquired (photographed) by a camera 12 (imaging device in a broad sense). Specifically, the image acquisition section 20 acquires an image from the camera 12 when the camera 12 has acquired an image of an imaging area IMR corresponding to a pointing position PP (i.e., imaging position) from the display image generated by embedding the marker image as the position detection pattern in the original image (i.e., a composite image of the original image and the marker image).

The pointing position PP is a position within the imaging area IMR, for example. The pointing position PP may be a center position (gaze point position) of the imaging area IMR, a corner position of the imaging area IMR, or the like. Note that FIG. 1 shows a large imaging area IMR for convenience of illustration. The actual imaging area IMR is sufficiently small as compared with the display screen. An area of the imaging area of the camera 12 around the gaze point position of the camera 12 may be set to be a position detection imaging area, and the pointing position PP may be detected based on the acquired image of the position detection imaging area.

Specifically, the imaging device included in the camera 12 acquires an image of the imaging area IMR that is smaller than the display area of the display image. The image acquisition section 20 acquires the image acquired by the imaging device, and the position detection section 24 detects the pointing position PP based on the acquired image of the imaging area IMR. This makes it possible to relatively increase the resolution even if the number of pixels of the imaging device is small, so that the pointing position PP can be detected with high accuracy.

The image correction section 22 performs an image correction process on the acquired image. For example, the image correction section 22 performs at least one of a rotation process and a scaling process on the acquired image. For example, the image correction section 22 performs an image correction process (e.g., rotation process or scaling process) that cancels a change in pan or tilt of the camera 12, rotation of the camera 12 around the visual axis, or the distance between the camera 12 and the display screen. For example, a sensor that detects rotation or the like may be provided in the camera 12, and the image correction section 22 may correct the acquired image based on information detected by the sensor. Alternatively, the image correction section 22 may detect the slope of a straight area (e.g., pixel or black matrix) of the display screen based on the acquired image, and may correct the acquired image based on the detection results.

The position detection section 24 detects the pointing position PP (indication position) based on the acquired image (e.g., the acquired image that has been subjected to the image correction process). For example, the position detection section 24 performs a calculation process that detects the marker image embedded in the acquired image based on the acquired image to determine the pointing position PP (indication position) corresponding to the imaging area IMR.

The calculation process performed by the position detection section 24 includes an image matching process that determines the degree of matching between the acquired image and the marker image. For example, the position detection section 24 performs the image matching process on the acquired image and each segmented area of the marker image, and detects the position of the segmented area for which the degree of matching becomes a maximum as the pointing position PP.

Specifically, the position detection section 24 calculates the cross-correlation between the acquired image and the marker image as the image matching process. The position detection section 24 determines the pointing position PP based on the cross-correlation calculation results (cross-correlation value or maximum cross-correlation value). In this case, the position detection section 24 may perform a high-pass filter process on the cross-correlation calculation results or the marker image. This makes it possible to utilize only a high-frequency region of the cross-correlation calculation results, so that the detection accuracy can be improved. Specifically, the original image is considered to have a high power in a low-frequency region. Therefore, the detection accuracy can be improved by removing a low-frequency component using the high-pass filter process.

The reliability calculation section 26 performs a reliability calculation process. For example, the reliability calculation section 26 calculates the reliability of the results of the image matching process performed on the acquired image and the marker image. The reliability calculation section 26 outputs the information about the pointing position as normal information when the reliability is high, and outputs error information or the like when the reliability is low. For example, when the position detection section 24 performs the cross-correlation calculation process as the image matching process, the reliability calculation section 26 calculates the reliability of the cross-correlation calculation results based on the maximum cross-correlation value and the distribution of the cross-correlation values.

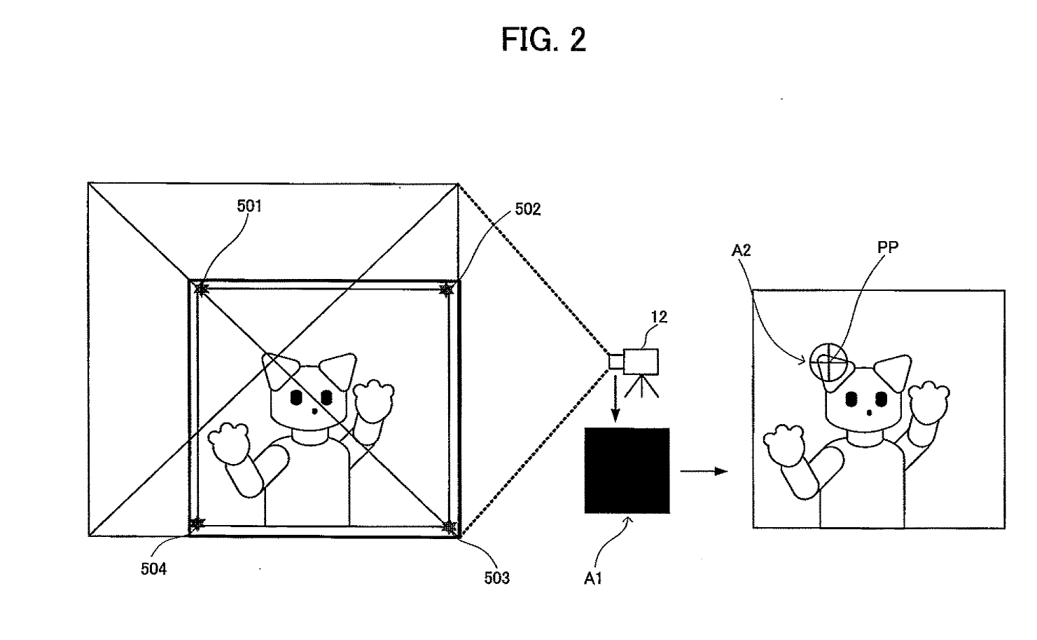

FIG. 2 shows a method according to a first comparative example of this embodiment. In the first comparative example, infrared LED 501, 502, 503, and 504 are disposed at the four corners of the display section (display), for example. The positions of the infrared LED 501 to 504 are detected from an image acquired by the camera 12 (see A1 in FIG. 2), and the pointing position PP is calculated based on the positions of the infrared LED 501 to 504 (see A2).

In the first comparative example, it is necessary to provide the infrared LED 501 to 504 in addition to the camera 12. This results in an increase in cost or the like. Moreover, a calibration process (i.e., initial setting) must be performed before the player starts the game so that the camera 12 can recognize the positions of the infrared LED 501 to 504. This process is troublesome for the player. Since the pointing position is detected based on a limited number of infrared LED 501 to 504, the detection accuracy and the disturbance resistance decrease.

On the other hand, since the position detection method according to this embodiment makes it unnecessary to provide the infrared LED 501 to 504 shown in FIG. 2, cost can be reduced. Moreover, since the calibration process is not required, convenience to the player can be improved. Since the pointing position is detected using the display image generated by embedding the marker image, the detection accuracy and the disturbance resistance can be improved as compared with the first comparative example shown in FIG. 2.

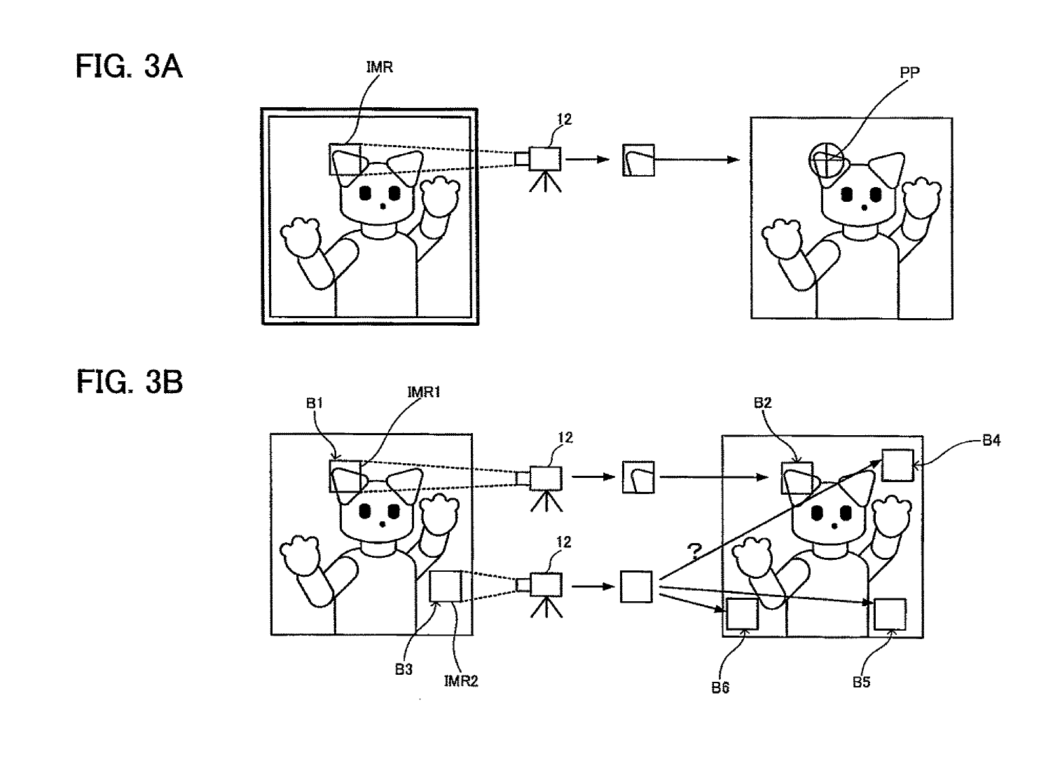

FIGS. 3A and 3B show a second comparative example of this embodiment. In the second comparative example, the image matching process is performed on the original image without embedding the marker image. As shown in FIG. 3A, an image of the imaging area IMR is acquired by the imaging device included in the camera 12, and the image matching process is performed on the acquired image and the original image to determine the pointing position PP.

In the second comparative example, when an image of an imaging area IMR1 indicated by B1 in FIG. 3B has been acquired by the camera 12, the imaging position can be specified (see B2). However, when an image of an imaging area IMR2 indicated by B3 has been acquired by the camera 12, whether the imaging position corresponds to a position B4, B5, or B6 cannot be specified.

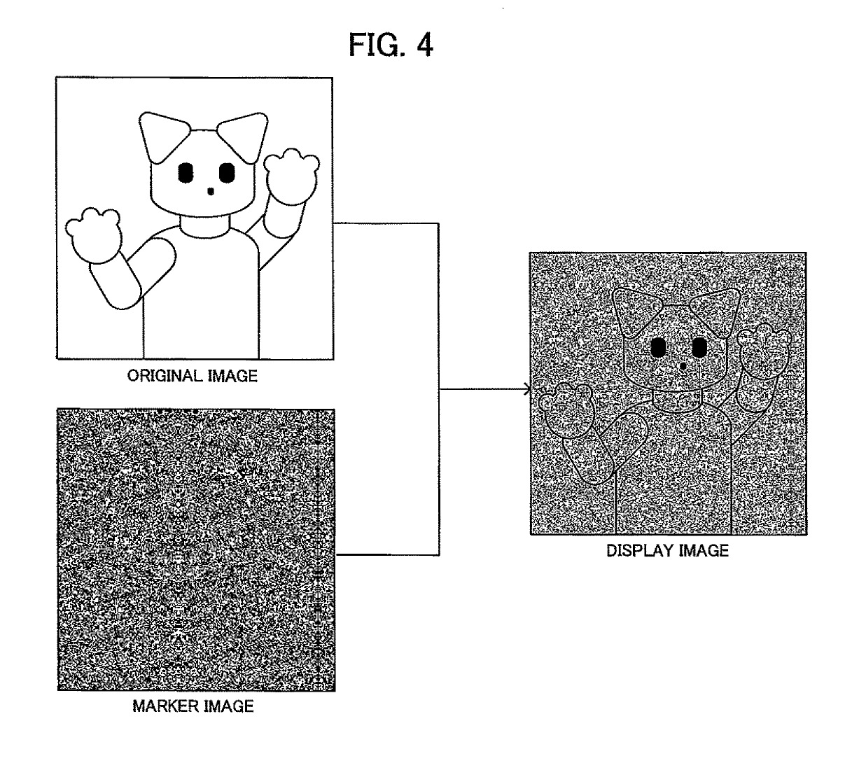

In order to solve this problem, the position detection method according to this embodiment provides a marker image (position detection pattern) shown in FIG. 4. The marker image is embedded in (synthesized with) the original image. For example, the display image is generated by embedding data in the original image by a method similar to a digital watermarking method, and displayed on the display section 190.

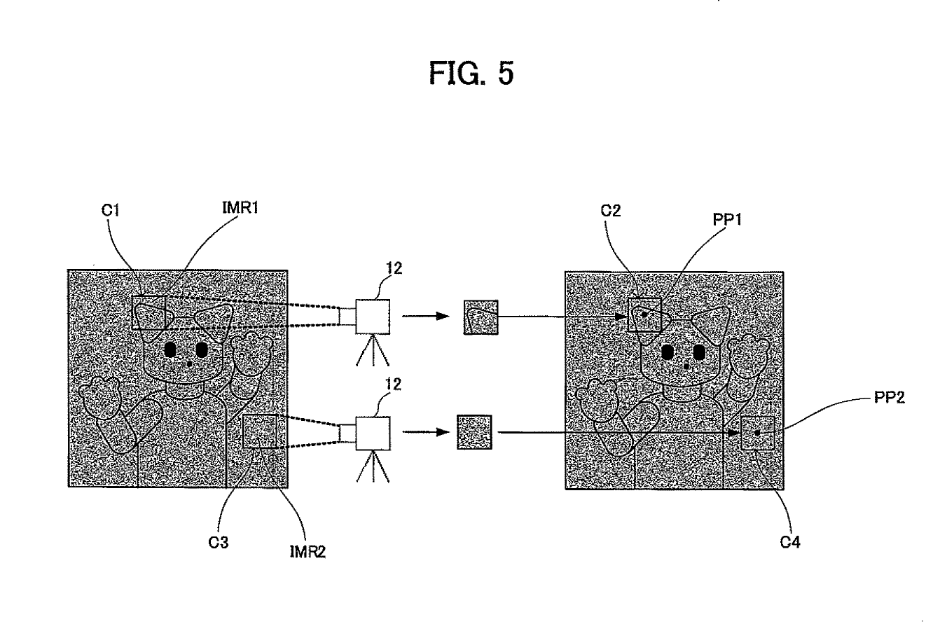

When an image of the imaging area IMR1 has been acquired by the camera 12 (imaging device) (see C1 in FIG. 5), a pointing position PP1 (i.e., the imaging position of the imaging area IMR1) is specified (see C2) by pattern matching between the acquired image and the marker image. When an image of the imaging area IMR2 has been acquired by the camera 12 (see C3), a pointing position PP2 (i.e., the imaging position of the imaging area IMR2) is specified (see C4) by pattern matching between the acquired image and the marker image. Specifically, the pointing position that cannot be specified in FIG. 3B (B3, B4, B5, and B6) can be specified by utilizing the marker image. Therefore, the pointing position can be specified with high accuracy without providing an infrared LED or the like.

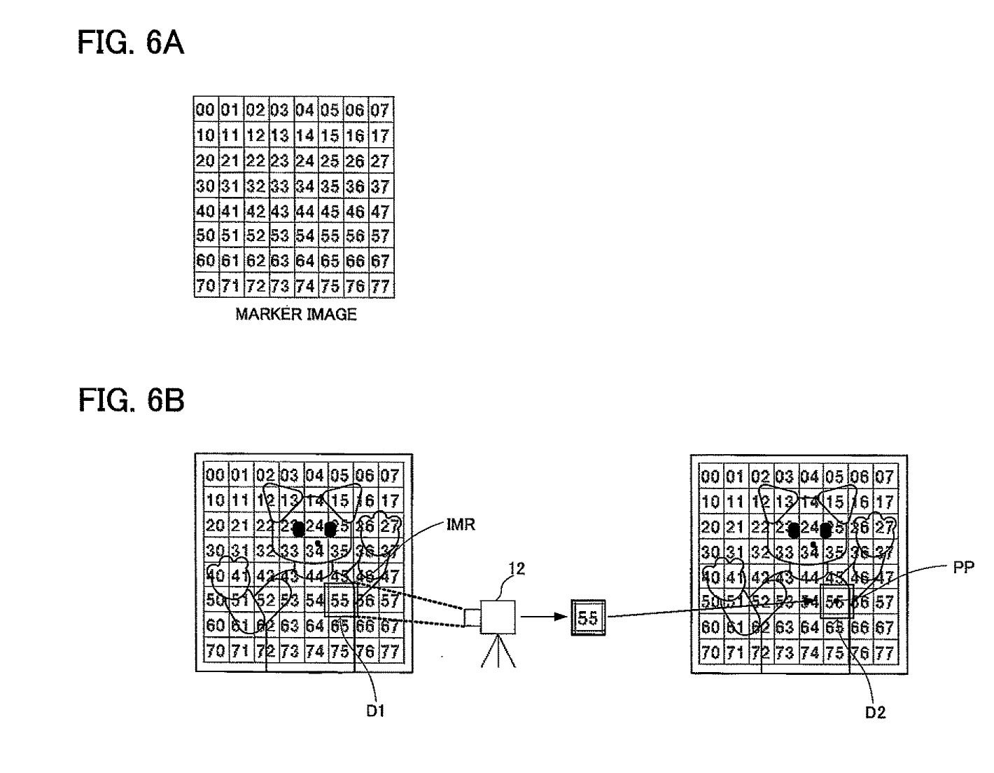

FIG. 6A schematically shows the marker image according to this embodiment. The marker image is a pattern used to detect a position on the display screen. For example, secret information that is hidden from the user is embedded by a digital watermarking method. In this embodiment, the position detection pattern is embedded instead of secret information.

As schematically shown in FIG. 6A, the position detection pattern has a unique data pattern in each segmented area of the display image (display screen). In FIG. 6A, the display image is divided into sixty-four segmented areas (eight rows and eight columns), and each segmented area includes a plurality of rows and a plurality of columns of pixels, for example. Unique marker image data (e.g., 00 to 77) is set to each segmented area. Specifically, a special pattern is set so that the marker image embedded in the acquired image of an arbitrary imaging area differs from the marker image embedded in the acquired image of another imaging area.

As indicated by D1 in FIG. 6B, marker image data “55” is extracted (detected) from the acquired image of the imaging area IMR, for example. The segmented area for which the marker image data “55” is set is the area indicated by D2. The pointing position PP is thus specified.

In this case, the matching process is performed on the marker image embedded in the acquired image and the marker image set to the corresponding segmented area instead of performing the matching process on the acquired image and the original image. Specifically, when the marker image embedded in the acquired image of the imaging area IMR indicated by D1 in FIG. 6B coincides with the marker image set to the segmented area corresponding to the imaging area IMR indicated by D1, the pointing position PP is specified (see D2).

2. Position Detection Process

An example of the position detection process is described below. Note that the position detection process according to this embodiment is not limited to the following method. It is possible to implement various modifications using various image matching processes.

2.1 Position Detection Using M-Array Marker Image

The data pattern of the marker image may be set using maximal-length sequence random numbers. Specifically, each pixel data of the marker image is set using an M-array (two-dimensionally extended maximal-length sequence). Note that the random number data used to generate the marker image data is not limited to the maximal-length sequence. For example, various PN sequences (e.g., Gold sequence) may be used.

The maximal-length sequence is a code sequence that is generated by shift registers having a given number of stages and feedback and has the maximal cycle. For example, the cycle of a kth-order (k corresponds to the number of stages of shift registers) maximal-length sequence is expressed by L=2^{k}−1. The M-array is a two-dimensional array of maximal-length sequence random numbers.

Specifically, Kth-order maximal-length sequences a₀ to a_{L-1} are generated, and disposed in the M-array (i.e., an array of M rows and N columns) in accordance with the following rule.

(I) The sequence a₀ is disposed at the upper left corner of the M-array.

(II) The sequence a₁ is disposed at the lower right of the sequence a₀. The subsequent sequence is sequentially disposed at the lower right of the preceding sequence.

(III) The sequences are disposed on the assumption that upper end and the lower end of the array are connected. Specifically, when the lowermost row has been reached, the subsequent sequence is disposed in the uppermost row. Likewise, the sequences are disposed on the assumption that the left end and the right end of the array are connected.

For example, when k=4, L=15, M=3, and N=5, the following M-array of three rows and five columns is generated.

$$[ \begin{matrix}{a}_{0} & {a}_{6} & {a}_{12} & {a}_{3} & {a}_{9} \\ {a}_{10} & {a}_{1} & {a}_{7} & {a}_{13} & {a}_{4} \\ {a}_{5} & {a}_{11} & {a}_{2} & {a}_{8} & {a}_{14}\end{matrix} ]$$

In this embodiment, the M-array thus generated is set to the pixel data of the marker image. The marker image is embedded by converting each pixel data of the original image using each pixel data of the marker image that is set using the M-array.

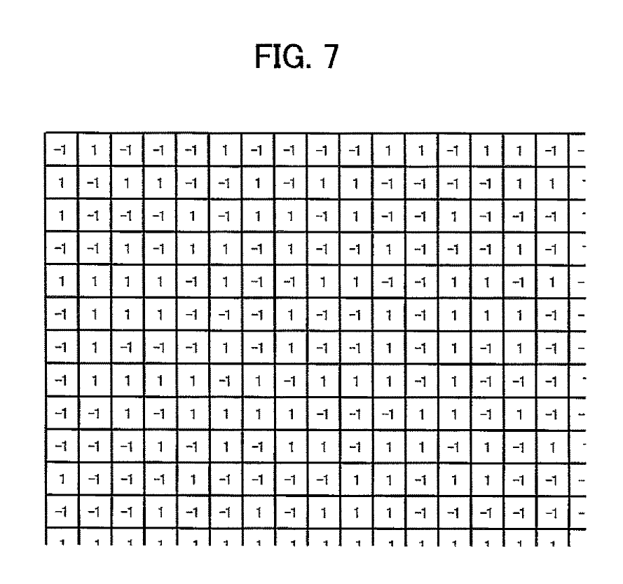

FIG. 7 shows a data example of the position detection pattern of the marker image that is generated using the M-array. Each square indicates the pixel, and “0” or “1” set to each square indicates the pixel data of the marker image. The maximal-length sequence random numbers (pseudo-random numbers) are “0” or “1”, and the values of the M-array are also “0” or “1”. In FIG. 7, “0” is indicated by “−1”. It is preferable to indicate “0” by “−1” in order to facilitate synthesis of the original image and the marker image.

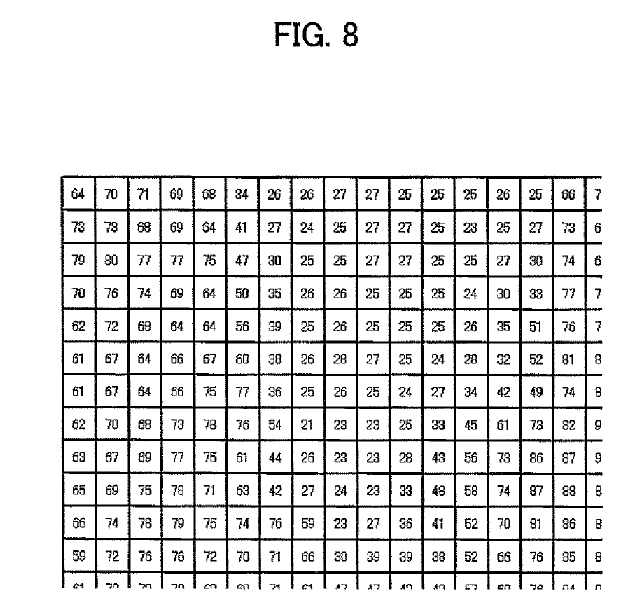

FIG. 8 shows a data example in the upper left area of the original image (game image). Each square indicates the pixel, and the value set to each square indicates the pixel data of the original image. Examples of the pixel data include R component data, G component data, B component data, color difference component data (U, V), and brightness component data (Y) of each pixel of the original image.

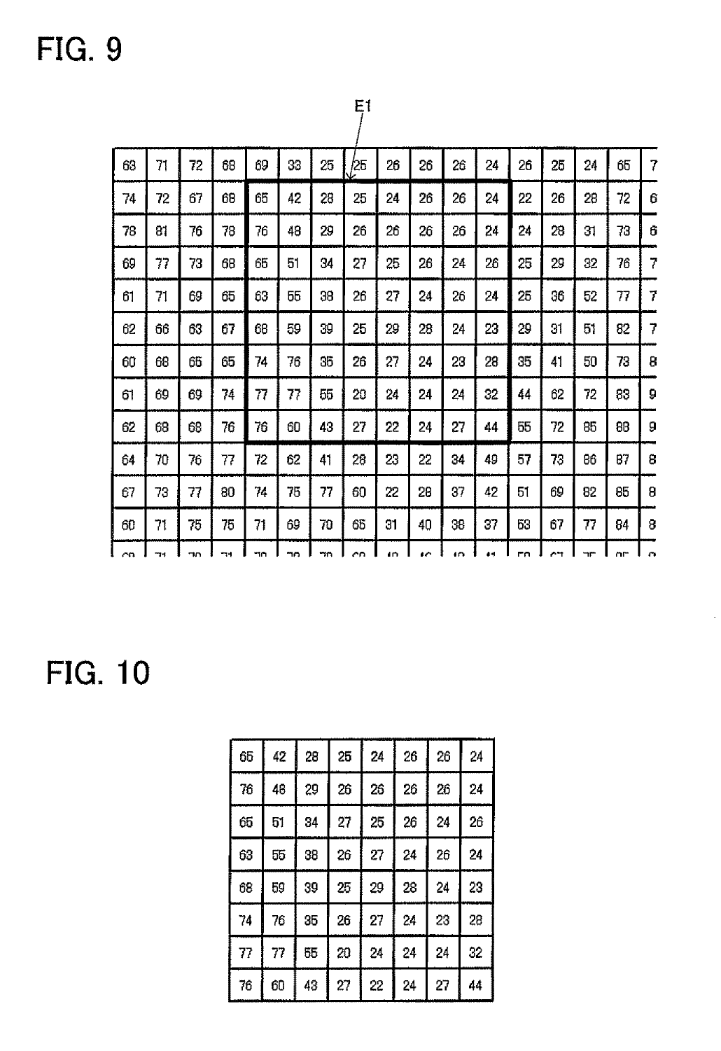

FIG. 9 shows a data example in the upper left area of the display image generated by embedding the marker image in the original image. The display image data shown in FIG. 9 is generated by incrementing or decrementing each pixel data of the original image shown in FIG. 8 by one based on the M-array. Specifically, each pixel data of the original image has been converted using each pixel data of the marker image that is set using the M-array.

FIG. 10 shows a data example of the image acquired by the imaging device (camera). FIG. 10 shows a data example of the acquired image of an area indicated by E1 in FIG. 9.

In this embodiment, the pointing position (imaging position) is detected from the data of the acquired image shown in FIG. 10. Specifically, a cross-correlation between the acquired image and the marker image is calculated, and the pointing position is detected based on the cross-correlation calculation results.

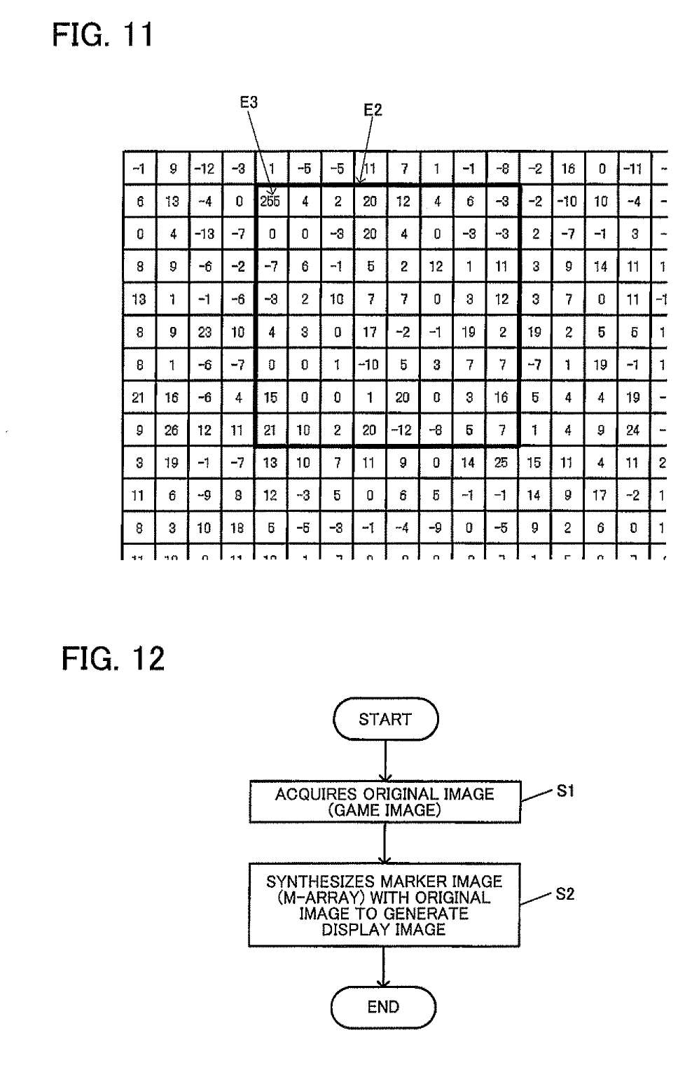

FIG. 11 shows an example of cross-correlation values obtained by the cross-correlation calculation process on the acquired image and the marker image. An area indicated by E2 in FIG. 11 corresponds to the area indicated by E1 in FIG. 9. A maximum value of 255 is obtained at a position indicated by E3 in FIG. 11. The position indicated by E3 corresponds to the imaging position. Specifically, the pointing position corresponding to the imaging position can be detected by searching the maximum cross-correlation value between the acquired image and the marker image. In FIG. 11, the upper left position (E3) of the imaging area is specified as the pointing position. Note that the center position, the upper right position, the lower left position, or the lower right position of the imaging area may be specified as the pointing position.

2.2 Process Flow

A process flow of the position detection method according to this embodiment is described below using flowcharts shown in FIGS. 12 to 15.

FIG. 12 is a flowchart showing the marker image embedding process. The original image (game image) is acquired (generated) (step S1). The marker image (M-array) is synthesized with the original image (see FIG. 4) to generate the display image in which the marker image is synthesized (see FIG. 9) (step S2). Note that the image generation device (game device) described later may synthesize (embed) the marker image with the original image, or a pointing device (position detection device) (e.g., gun-type controller) may receive the original image from the image generation device, and synthesize the marker image with the original image.

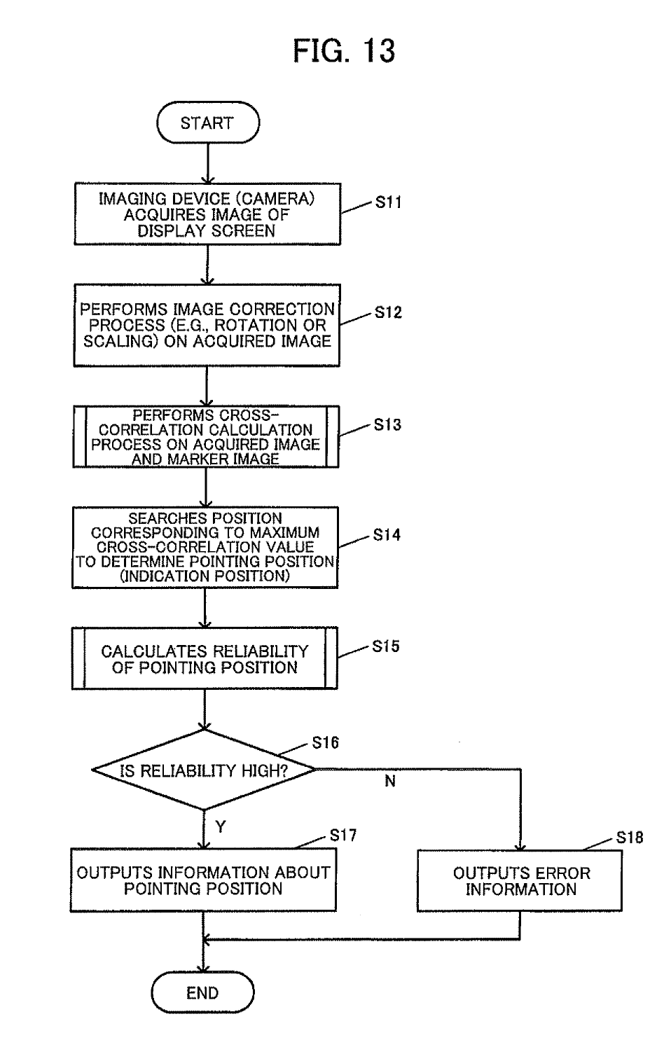

FIG. 13 is a flowchart showing the position detection process. The imaging device (camera) acquires an image of the display screen displayed on the display section 190, as described with reference to FIGS. 5 and 10 (step S11). The image correction process (e.g., rotation or scaling) is performed on the acquired image (step S12). Specifically, the image correction process is performed to compensate for a change in position or direction of the imaging device. The cross-correlation calculation process is performed on the acquired image and the marker image (step S13) to calculate the cross-correlation values described with reference to FIG. 11.

A position corresponding to the maximum cross-correlation value is searched to determine the pointing position (indication position) (step S14). For example, the position indicated by E3 in FIG. 11 corresponding to the maximum cross-correlation value is determined to be the pointing position.

The reliability of the pointing position is then calculated (step S15). When the reliability of the pointing position is high, information about the pointing position is output to the image generation device (game device) described later or the like (steps S16 and S17). When the reliability of the pointing position is low, error information is output (step S18).

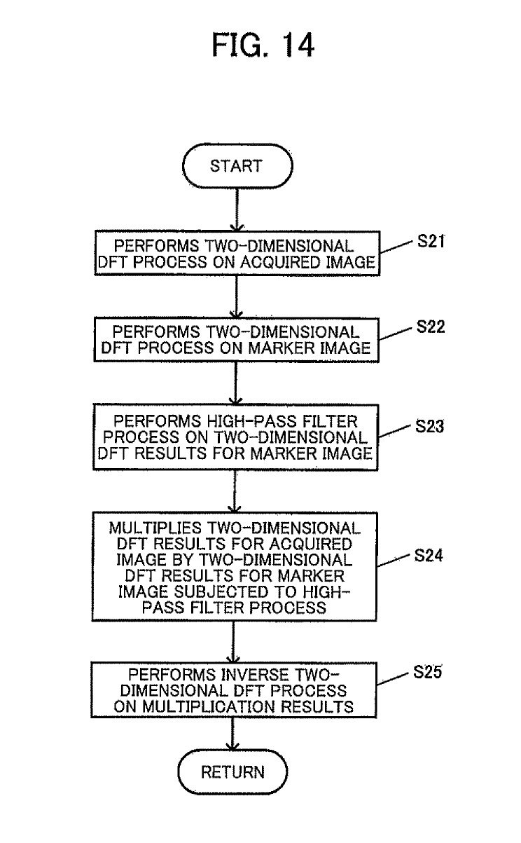

FIG. 14 is a flowchart showing the cross-correlation calculation process (step S13 in FIG. 13). A two-dimensional DFT process is performed on the acquired image described with reference to FIG. 10 (step S21). A two-dimensional DFT process is also performed on the marker image described with reference to FIG. 7 (step S22).

A high-pass filter process is performed on the two-dimensional DFT results for the marker image (step S23). The original image (e.g., game image) has high power in a low-frequency region. On the other hand, the M-array image has equal power over the entire frequency region. The power of the original image in a low-frequency region serves as noise during the position detection process. Therefore, the power of noise is reduced by reducing the power of a low-frequency region by the high-pass filter process that removes a low-frequency component. This reduces erroneous detection.

Note that the high-pass filter process may be performed on the cross-correlation calculation results. However, when implementing the cross-correlation calculation process by DFT, the process can be performed at high speed by performing the high-pass filter process on the two-dimensional DFT results for the marker image (M-array). When the marker image is not changed in real time, the two-dimensional DFT process on the marker image and the high-pass filter process on the two-dimensional DFT results may be performed once during initialization.

The two-dimensional DFT results for the acquired image obtained in the step S21 are multiplied by the two-dimensional OFT results for the marker image subjected to the high-pass filter process in the step S23 (step S24). An inverse two-dimensional DFT process is performed on the multiplication results to calculate the cross-correlation values shown in FIG. 11 (step S25).

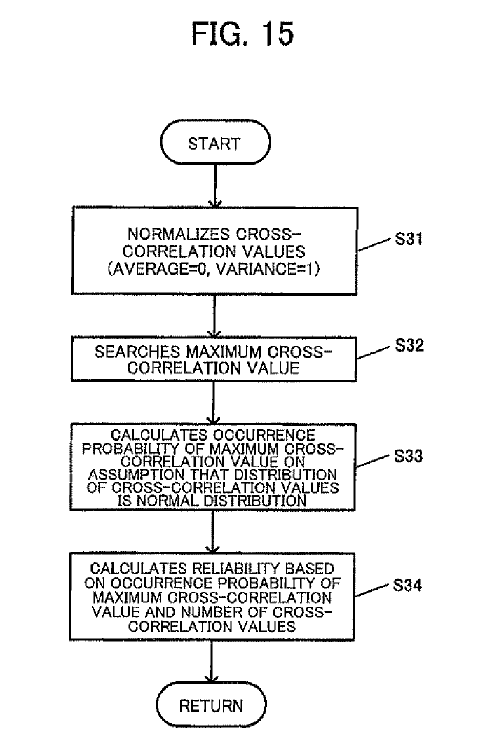

FIG. 15 is a flowchart showing the reliability calculation process (step S15 in FIG. 13). The cross-correlation values are normalized (average=0, variance=1) (step S31). The maximum cross-correlation value is searched (see E3 in FIG. 11) (step S32).

The occurrence probability of the maximum cross-correlation value is calculated on the assumption that the distribution of the cross-correlation values is a normal distribution (step S33). The reliability is calculated based on the occurrence probability of the maximum cross-correlation value and the number of cross-correlation values (step S34).

2.3 cross-correlation calculation process

The details of the cross-correlation calculation process shown in FIG. 14 are described below. The two-dimensional DFT process is described below.

For example, the two-dimensional DFT (two-dimensional discrete Fourier transform) process on M×N-pixel image data x(m, n) is expressed by the following expression (1).

$$X ( k , l ) = {\sum }_{m = 0}^{M - 1} {\sum }_{n = 0}^{N - 1} x ( m , n ) exp \{ - 2 πi ( \frac{m k}{M} + \frac{n l}{N} ) \} \qquad ( 1 )$$

where, k=0, 1, . . . , M−1, 1=0, 1, . . . , N−1, and i is an imaginary unit.

The two-dimensional OFT process may be implemented using the one-dimensional DFT process. Specifically, the one-dimensional DFT process is performed on each row of the array (image data) x(m, n) to obtain an array X′. More specifically, the one-dimensional DFT process is performed on the first row (0, n) of the array x(m, n), and the results are set in the first row of the array X′ (see the following expression (2)).

$${X}^{′} ( 0 , l ) = {\sum }_{n = 0}^{N - 1} x ( 0 , n ) exp ( - 2 πi \frac{n l}{N} ) \qquad ( 2 )$$

Likewise, the one-dimensional DFT process is performed on the second row, and the results are set in the second row of the array X′. The above process is repeated N times to obtain the array X′. The one-dimensional DFT process is then performed on each column of the array X′. The results are expressed by X(k, 1) (two-dimensional DFT results). The inverse two-dimensional DFT process may be implemented by applying the inverse one-dimensional DFT process to each row and each column.

Various fast Fourier transform (FFT) algorithms are known as the one-dimensional DFT process. The two-dimensional DFT process can be implemented at high speed by utilizing such an algorithm.

Note that X(k, 1) corresponds to the spectrum of the image data x(m, n). For example, when performing the high-pass filter process on the image data, a low-frequency component of the array X(k, 1) may be removed. Specifically, since a low-frequency component corresponds to each corner of the array X(k, 1), the high-pass filter process may be implemented by replacing the value at each corner with 0.

A cross-correlation is described below. A cross-correlation R(i, j) between two-dimensional arrays A and B of M rows and N columns is expressed by the following expression (3).

$$R ( i , j ) = \frac{1}{M N} {\sum }_{n = 0}^{N - 1} {\sum }_{m = 0}^{M - 1} A ( m , n ) B ( m + i , n + j ) \qquad ( 3 )$$

When m+i>M−1, the value is set to m+i−M. Specifically, the right end and the left end of the array B are circularly connected. This also applies to the upper end and the lower end of the array B.

When the arrays A and B are identical M-arrays, only the cross-correlation R(0, 0) has a significantly large value, and other cross-correlations have a value close to 0. When moving the array A by i rows and j columns, only the cross-correlation R(i, j) has a significantly large value. The difference in position between two M-arrays can be determined from the maximum value of the cross-correlation R by utilizing the above properties.

The cross-correlation R may be calculated using the two-dimensional DFT process instead of directly calculating the cross-correlation R using the expression (3). In this case, since a fast Fourier transform algorithm can be used, the process can be performed at high speed as compared with the case of directly calculating the cross-correlation R.

Specifically, the two-dimensional DFT process is performed on the arrays A and B to obtain results A′ and B′. The corresponding values of the results A′ and B′ are multiplied to obtain results C. Specifically, the value in the mth row and the nth column of the results A′ is multiplied (complex-multiplied) by the value in the mth row and the nth column of the results B′ to obtain the value in the mth row and the nth column of the results C. Specifically, C(m, n)=A′(m, n)×B′(m, n). The inverse two-dimensional DFT process is performed on the value C(m, n) to obtain the cross-correlation R(m, n).

2.4 Reliability

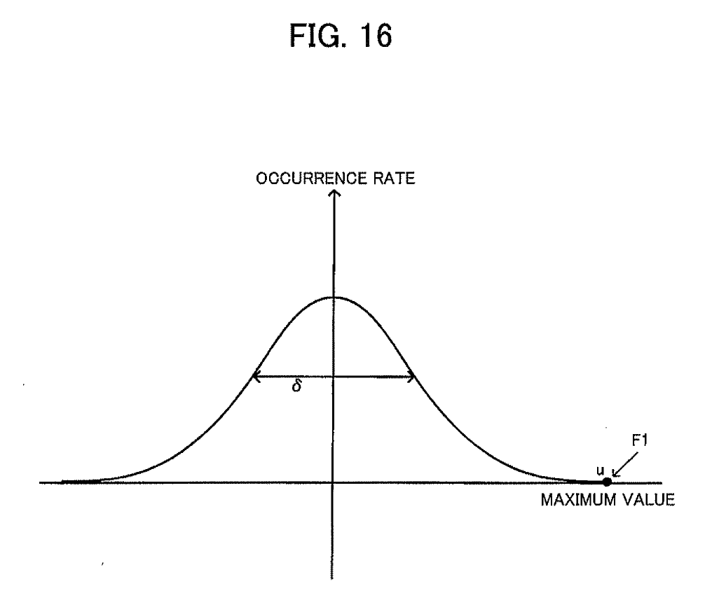

The details of the reliability calculation process shown in FIG. 15 are described below. FIG. 16 shows an example in which the distribution of the cross-correlation values is a normal distribution.

The average and the variance of N×M pieces of data included in the cross-correlation R(i, j) are calculated to normalize the cross-correlation R(i, j) (average=0, variance=1). The maximum value of the normalized data (i.e., data corresponding to the pointing position) is referred to as u (see F1 in FIG. 16). The upper probability P(u) of the maximum value u in the normal distribution is calculated. Specifically, the occurrence probability of the maximum value u in the normal distribution is calculated.

For example, the upper probability P(u) in the normal distribution (average=0, variance=1) is expressed by the following expression (4).

$$P ( u ) = {\int }_{u}^{∞} \frac{1}{\sqrt{2 π}} exp ( - \frac{{x}^{2}}{2} ) d x \qquad ( 4 )$$

The upper probability P(u) is calculated using Shenton's continued fraction expansion shown by the following expression (5), for example.

$$P ( u ) = \frac{1}{2} - \frac{1}{\sqrt{2 π}} exp ( - \frac{{u}^{2}}{2} ) \times \frac{u}{1 - \frac{{u}^{2}}{3 + \frac{2 {u}^{2}}{5 - \frac{3 {u}^{2}}{…}}}} \qquad ( 5 )$$

The reliability s is defined by the following expression (6).

s={1−P(u)}^{N×M} (6)

The reliability s is a value from 0 to 1. The position information (pointing position or imaging position) calculated from the maximum value u has higher reliability as the reliability s becomes closer to 1. The reliability s is not a probability that the position information is accurate. Specifically, the upper probability P(u) corresponds to the probability that the value of the position information occurs when the marker image is not watermarked, and the reliability s is a value corresponding to 1−P(u). For example, the reliability s is expressed by “s={1−P(u)}^{N×M} (see the expression (6)). Specifically, when the reliability s is close to 1, it is likely that the marker image is watermarked. Therefore, it is considered that the watermark of the marker image is detected, and the position information is reliable.

Note that the upper probability P(u) may be directly used as the reliability. Specifically, since the quantitative relationship of the reliability coincides with the quantitative relationship of the upper probability P(u), the upper probability P(u) may be directly used as the reliability when the position information is considered to be reliable only when the reliability is equal to or larger than a given value.

3. Image Generation Device

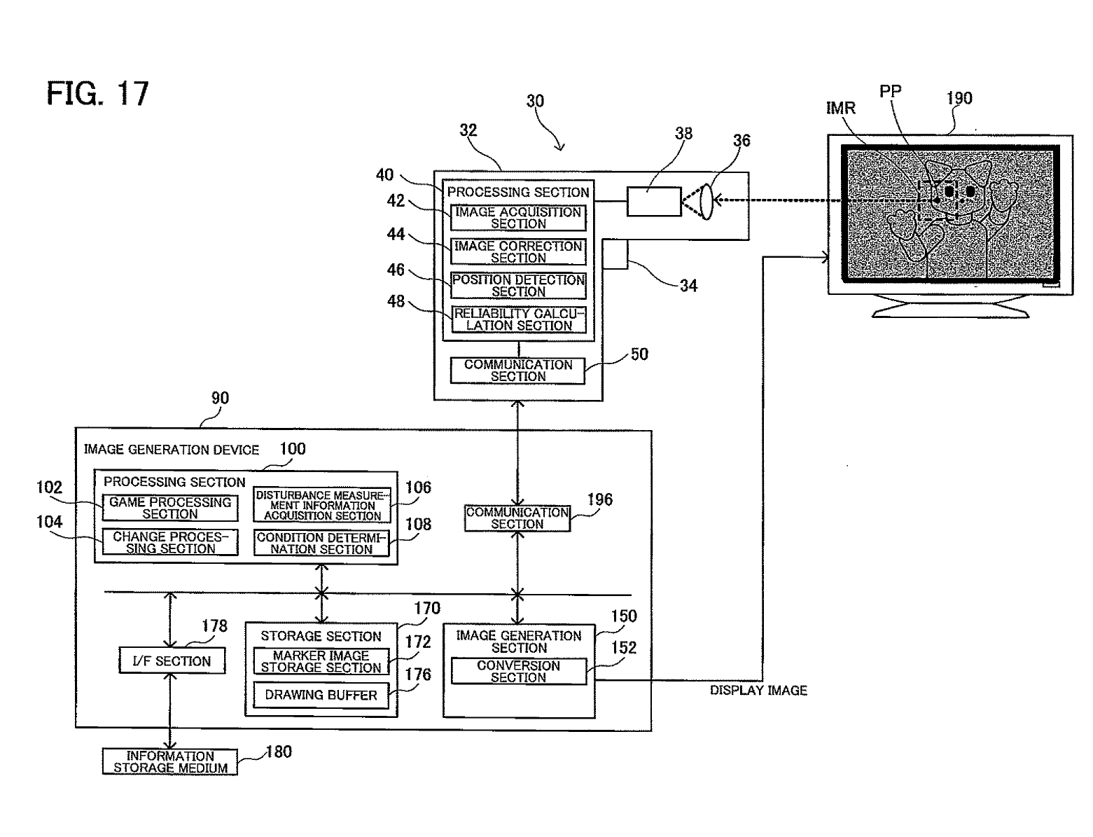

A configuration example of an image generation device and a pointing device (gun-type controller) to which the position detection system according to this embodiment is applied is described below with reference to FIG. 17. Note that the image generation device and the like according to this embodiment are not limited to the configuration shown in FIG. 17. Various modifications may be made, such as omitting some of the elements or adding other elements. In FIG. 17, a gun-type controller 30 includes an image correction section 44, a position detection section 46, and a reliability calculation section 48. Note that the sections may be provided in an image generation device 90.

In the example shown in FIG. 17, the player holds the gun-type controller 30 (pointing device or shooting device in a broad sense) that imitates a gun, and pulls a trigger 34 aiming at a target object (target) displayed on the screen of the display section 190. An imaging device 38 of the gun-type controller 30 then acquires an image of the imaging area IMR corresponding to the pointing position of the gun-type controller 30. The pointing position PP (indication position) of the gun-type controller 30 (pointing device) is detected by the method described with reference to FIGS. 1 to 16 based on the acquired image. It is determined that the target object has been hit when the pointing position PP of the gun-type controller 30 coincides with the position of the target object displayed on the screen, and it is determined that the target object has not been hit when the pointing position PP of the gun-type controller 30 does not coincide with the position of the target object displayed on the screen.

The gun-type controller 30 includes an indicator 32 (casing) that is formed to imitate the shape of a gun, the trigger 34 that is provided on the grip of the indicator 32, and a lens 36 (optical system) and the imaging device 38 that are provided near the muzzle of the indicator 32. The gun-type controller 30 also includes a processing section 40 and a communication section 50. Note that the gun-type controller 30 (pointing device) is not limited to the configuration shown in FIG. 17. Various modifications may be made, such as omitting some of the elements or adding other elements (e.g., storage section).

The imaging device 38 is formed by a sensor (e.g., CCD or CMOS sensor) that can acquire an image. The processing section 40 (control circuit) controls the entire gun-type controller, and calculates the indication position, for example. The communication section 50 exchanges data between the gun-type controller 30 and the image generation device 90 (main device). The functions of the processing section 40 and the communication section 50 may be implemented by hardware (e.g., ASIC), or may be implemented by a processor (CPU) and software.

The processing section 40 includes an image acquisition section 42, the image correction section 44, the position detection section 46, and the reliability calculation section 48.

The image acquisition section 42 acquires an image acquired by the imaging device 38. Specifically, the image acquisition section 42 acquires an image from the imaging device 38 when the imaging device 38 has acquired an image of the imaging area IMR corresponding to the pointing position PP from the display image generated by embedding the marker image in the original image. The image correction section 44 performs the image correction process (e.g., rotation process or scaling process) on the acquired image.

The position detection section 46 performs a calculation process that detects the marker image embedded (synthesized) in the acquired image based on the acquired image to determine the pointing position PP corresponding to the imaging area IMR. Specifically, the position detection section 46 calculates a cross-correlation between the acquired image and the marker image to determine the pointing position PP. The reliability calculation section 48 calculates the reliability of the pointing position PP. Specifically, the reliability calculation section 48 calculates the reliability of the pointing position PP based on the maximum cross-correlation value and the distribution of the cross-correlation values.

The image generation device 90 (main device) includes a processing section 100, an image generation section 150, a storage section 170, an interface (IIF) section 178, and a communication section 196. Note that various modifications may be made, such as omitting some of the elements or adding other elements.

The processing section 100 (processor) controls the entire image generation device 90, and performs various processes (e.g., game process) based on data from an operation section of the gun-type controller 30, a program, and the like. Specifically, when the marker image embedded in the acquired image has been detected based on the acquired image of the display image displayed on the display section 190, and the pointing position PP corresponding to the imaging area IMR has been determined, the processing section 100 performs various calculation processes based on the determined pointing position PP. For example, the processing section 100 performs the game process including a game result calculation process based on the pointing position. The function of the processing section 100 may be implemented by hardware such as a processor (e.g., CPU or GPU) or an ASIC (e.g., gate array), or a program.

The image generation section 150 (drawing section) performs a drawing process based on the results of various processes performed by the processing section 100 to generate a game image, and outputs the generated game image to the display section 190. When generating a three-dimensional game image, the image generation section 150 performs a geometric process (e.g., coordinate transformation, clipping, perspective transformation, or light source calculations), and generates drawing data (e.g., primitive surface vertex (constituent point) position coordinates, texture coordinates, color (brightness) data, normal vector, or alpha-value) based on the results of the geometric process, for example. The image generation section 150 draws the object (one or more primitive surfaces) subjected to the geometric process in a drawing buffer 176 (i.e., a buffer (e.g., frame buffer or work buffer) that can store pixel-unit image information) based on the drawing data (primitive surface data). The image generation section 150 thus generates an image viewed from a virtual camera (given viewpoint) in an object space. Note that the image that is generated according to this embodiment and displayed on the display section 190 may be a three-dimensional image or a two-dimensional image.

The image generation section 150 generates a display image by embedding the marker image as the position detection pattern in the original image, and outputs the generated display image to the display section 190. Specifically, a conversion section 152 included in the image generation section 150 generates the display image by converting each pixel data of the original image using each pixel data (M-array) of the marker image. For example, the conversion section 152 generates the display image by converting at least one of R component data, G component data, and B component data of each pixel of the original image, or at least one of color difference component data and brightness component data (YIN) of each pixel of the original image using each pixel data of the marker image.

The image generation section 150 may output the original image as the display image when a given condition has not been satisfied, and may output an image generated by embedding the marker image in the original image as the display image when the given condition has been satisfied. For example, the image generation section 150 may generate a position detection original image (position detection image) as the original image when the given condition has been satisfied, and may output an image generated by embedding the marker image in the position detection original image as the display image. Alternatively, the image generation section 150 may output an image generated by embedding the marker image in the original image as the display image when the image generation section 150 has determined that a position detection timing has been reached based on instruction information (trigger input information) from the gun-type controller 30 (pointing device). The image generation section 150 may output an image generated by embedding the marker image in the original image as the display image when a given game event has occurred during the game process.

The storage section 170 serves as a work area for the processing section 100, the communication section 196, and the like. The function of the storage section 170 may be implemented by a RAM (DRAM or VRAM) or the like. The storage section 170 includes a marker image storage section 172, the drawing buffer 176, and the like.

The interface (I/F) section 178 functions as an interface between the image generation device 90 and an information storage medium 180. The interface (I/F) section 178 accesses the information storage medium 180, and reads a program and data from the information storage medium 180.

The information storage medium 180 (computer-readable medium) stores a program, data, and the like. The function of the information storage medium 180 may be implemented by an optical disk (CD or DVD), a hard disk drive (HDD), a memory (e.g., ROM), or the like. The processing section 100 performs various processes according to this embodiment based on a program (data) stored in the information storage medium 180. Specifically, a program that causes a computer (i.e., a device including an operation section, a processing section, a storage section, and an output section) to function as each section according to this embodiment (i.e., a program that causes a computer to execute the process of each section) is stored in the information storage medium 180.

A program (data) that causes a computer to function as each section according to this embodiment may be distributed to the information storage medium 180 (or storage section 170) from an information storage medium included in a host device (server) via a network and the communication section 196. Use of the information storage medium included in the host device (server) is included within the scope of the invention.

The display section 190 outputs an image generated according to this embodiment. The function of the display section 190 may be implemented by a CRT, an LCD, a touch panel display, or the like.

The communication section 196 communicates with the outside (e.g., gun-type controller 30) via a cable or wireless network. The function of the communication section 196 may be implemented by hardware (e.g., communication ASIC or communication processor) or communication firmware.

The processing section 100 includes a game processing section 102, a change processing section 104, a disturbance measurement information acquisition section 106, and a condition determination section 108.

The game processing section 102 performs various game processes (e.g., game result calculation process). The game process includes calculating the game results, determining the details of the game and the game mode, starting the game when game start conditions have been satisfied, proceeding with the game, and finishing the game when game finish conditions have been satisfied, for example.

For example, the game processing section 102 performs a hit check process based on the pointing position PP detected by the gun-type controller 30. Specifically, the game processing section 102 performs a hit check process on a virtual bullet (shot) fired from the gun-type controller 30 (weapon-type controller) and the target object (target).

More specifically, the game processing section 102 (hit processing section) determines the trajectory of the virtual bullet based on the pointing position PP determined based on the acquired image, and determines whether or not the trajectory intersects the target object disposed in the object space. The game processing section 102 determines that the virtual bullet has hit the target object when the trajectory intersects the target object, and performs a process that decreases the durability value (strength value) of the target object, a process that generates an explosion effect, a process that changes the position, direction, motion, color, or shape of the target object, and the like. The game processing section 102 determines that the virtual bullet has not hit the target object when the trajectory does not intersect the target object, and performs a process that causes the virtual bullet to disappear, and the like. Note that a simple object (bounding volume or bounding box) that simply represents the shape of the target object may be provided, and a hit check between the simple object and the virtual bullet (trajectory of the virtual bullet) may be performed.

The change processing section 104 changes the marker image or the like. For example, the change processing section 104 changes the marker image with the lapse of time. The change processing section 104 changes the marker image depending on the status of the game that progresses based on the game process performed by the game processing section 102, for example. Alternatively, the change processing section 104 changes the marker image based on the reliability of the pointing position PP, for example. When a cross-correlation between the acquired image and the marker image has been calculated, and the reliability of the cross-correlation calculation results has been determined, the change processing section 104 changes the marker image based on the determined reliability. The change processing section 104 may change the marker image corresponding to the original image. For example, when a different game image is generated depending on the game stage, the change processing section 104 changes the marker image depending on the game stage. When using a plurality of marker images, data of the plurality of marker images is stored in the marker image storage section 172.

The disturbance measurement information acquisition section 106 acquires measurement information about a disturbance (e.g., sunlight). Specifically, the disturbance measurement information acquisition section 106 acquires disturbance measurement information from a disturbance measurement sensor (not shown). The change processing section 104 changes the marker image based on the acquired disturbance measurement information. For example, the change processing section 104 changes the marker image based on the intensity, color, or the like of ambient light.

The condition determination section 108 determines whether or not a given marker image change condition has been satisfied due to a shooting operation or occurrence of a game event. The change processing section 104 changes (switches) the marker image when the given marker image change condition has been satisfied. The image generation section 150 outputs the original image as the display image when the given marker image change condition has not been satisfied, and outputs an image generated by embedding the marker image in the original image as the display image when the given marker image change condition has been satisfied.

4. Marker Image Change Process

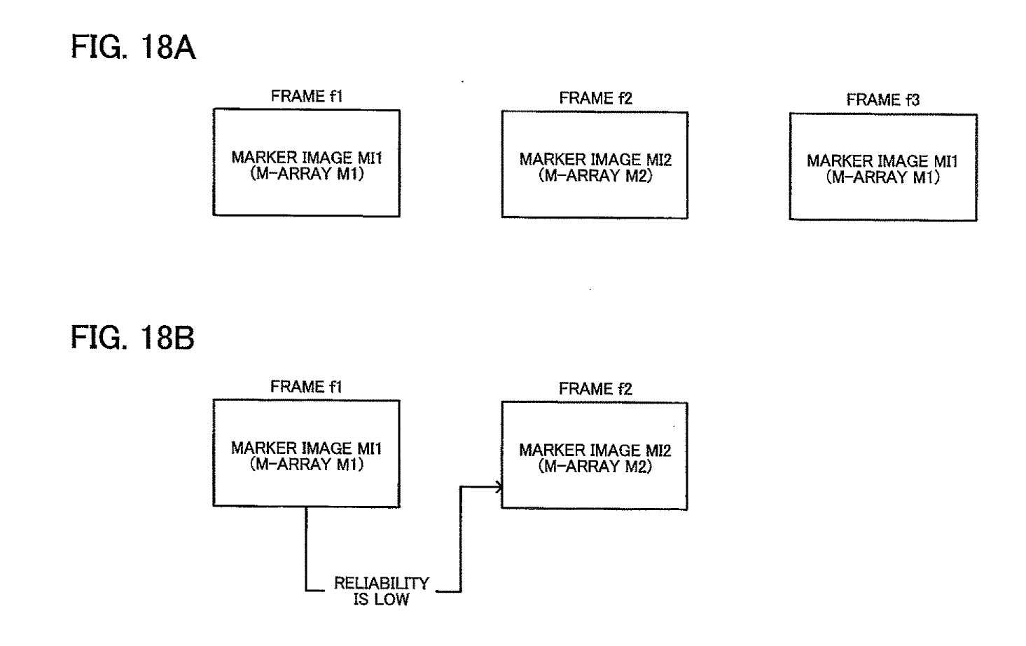

In this embodiment, the pattern of the marker image embedded in the original image may be changed. In FIG. 18A, the marker image is changed with the lapse of time. Specifically, a display image in which a marker image MI1 is embedded is generated in a frame f1, a display image in which a marker image MI2 differing from the marker image MI2 is embedded is generated in a frame f2 (f2<f2), and a display image in which the marker image MI1 is embedded is generated in a frame f3 (f2<f3).

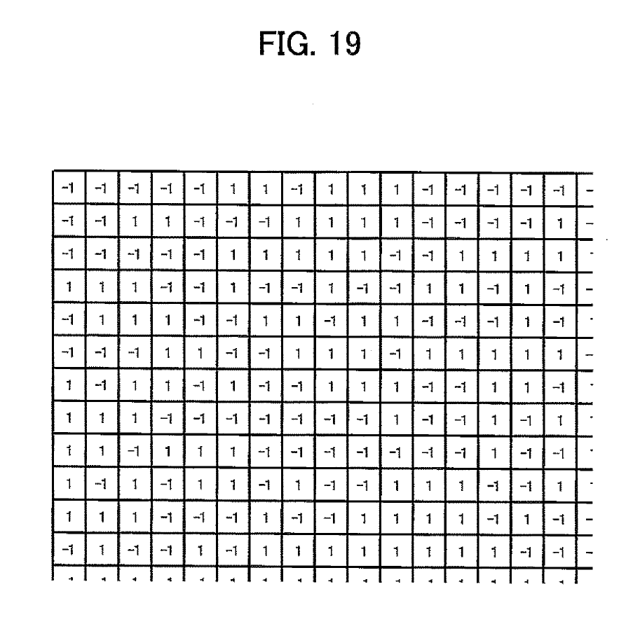

For example, the marker image MI1 is generated using a first M-array M1, and the marker image MI2 is generated using a second M-array M2. For example, the array shown in FIG. 7 is used as the first M-array M1, and an array shown in FIG. 19 is used as the second M-array M2. The first M-array M1 and the second M-array M2 differ in pattern.

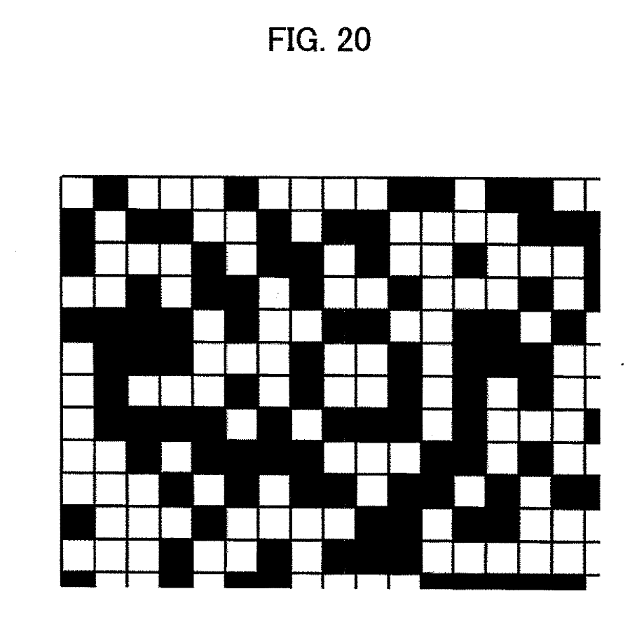

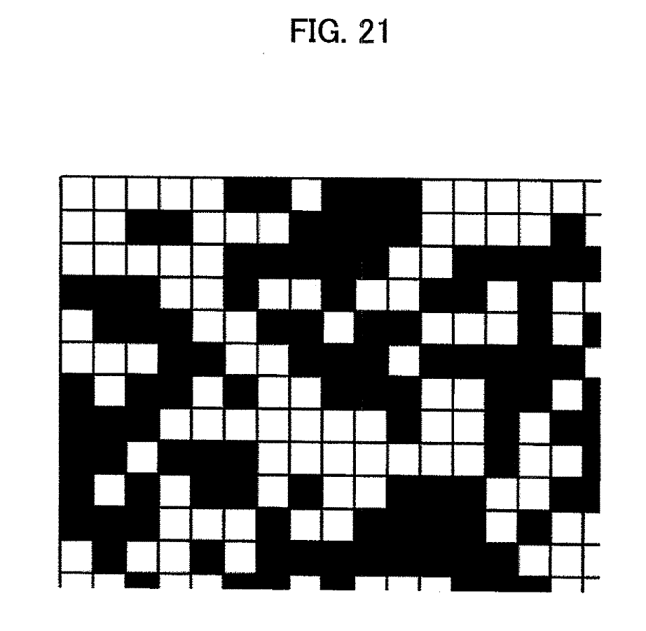

FIG. 20 is a view showing the marker image MI1 generated using the first M-array M1, and FIG. 21 is a view showing the marker image MI2 generated using the second M-array M2. In FIGS. 20 and 21, “1” is schematically indicated by a black pixel, and “−1” is schematically indicated by a white pixel.

The total amount of information included in the marker image increases by changing the marker image with the lapse of time, so that the detection accuracy can be improved. For example, when the pointing position detection accuracy cannot be increased using the marker image MI1 generated using the first M-array M1 depending on the conditions (e.g., surrounding environment), the detection accuracy can be improved by displaying an image generated by embedding the marker image MI2 generated using the second M-array M2 in the original image. The marker image cannot be changed by a method that embeds the marker image in a printed matter, for example. However, the marker image can be changed by the method according to this embodiment that displays an image generated by embedding the marker image in the original image on the display section 190.

When changing the marker image as shown in FIG. 18A, the image generation device 90 (processing section) shown in FIG. 17 may transmit data that indicates the type of marker image used for the image that is currently displayed on the display section 190 to the gun-type controller 30. Specifically, information about the marker image embedded in the display image is necessary for the gun-type controller 30 to perform the position detection process. Therefore, the gun-type controller 30 must have a function corresponding to that of the marker image storage section 172, and information that indicates the type of currently used marker image must be transmitted from the image generation device 90 to the gun-type controller 30. In this case, it is a waste of processing resources to transmit information about the marker image each time the marker image is changed. Therefore, the ID and pattern information of the marker image may be transmitted to the gun-type controller 30 when the game starts, and stored in a storage section (not shown) of the gun-type controller 30, for example.

The marker image embedded in the original image may be changed based on the reliability described with reference to FIG. 15, for example. In FIG. 18B, the marker image MI1 generated using the first M-array M1 is embedded in the frame The reliability when using the marker image MI1 is calculated. When the calculated reliability is lower than a given reference value, the marker image MI2 generated using the second M-array M2 is embedded in the subsequent frame f2 to detect the pointing position. According to this configuration, since an optimum marker image is selected and embedded in the original image when the surrounding environment has changed, the detection accuracy can be significantly improved as compared with the case of using a single marker image.

Although FIGS. 18A and 18B show an example in which two marker images are selectively used, three or more marker images may also be selectively used. A plurality of marker images may differ in array pattern used to generate each marker image, or may differ in depth of the pattern.

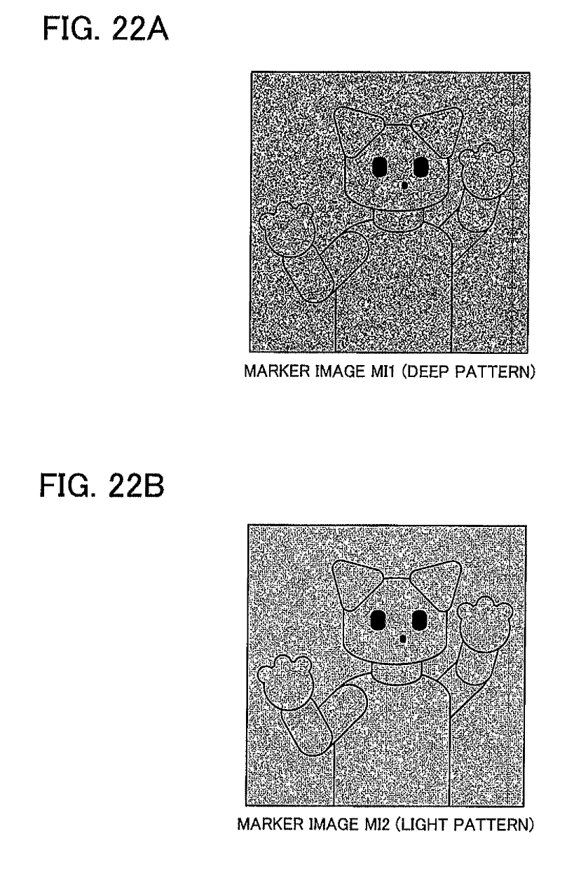

For example, a marker image MI1 having a deep pattern is used in FIG. 22A, and a marker image MI2 having a light pattern is used in FIG. 22B. The marker images MI1 and MI2 that differ in depth may be selectively used depending on the elapsed time.

Specifically, when using the deep pattern shown in FIG. 22A, the marker image may be conspicuous for the player. On the other hand, the marker image does not stand out when using the light pattern shown in FIG. 22B. The deep pattern shown in FIG. 22A may be generated by increasing the data value of the marker image that is added to or subtracted from the RGB data value (brightness) of the original image, and the light pattern shown in FIG. 22B may be generated by decreasing the data value of the marker image that is added to or subtracted from the RGB data value of the original image.

It is desirable that the marker image does not stand out in order to improve the quality of the display image displayed on the display section 190. Therefore, it is desirable to use the light pattern shown in FIG. 22B. It is desirable to add the data value of the marker image to the color difference component of the original image in order to render the marker image more inconspicuous. Specifically, the RGB data of the original image is converted into YUV data by a known method. The data value of the marker image is added to or subtracted from at least one of the color difference data U and V(Cb, Cr) of the YUV data to embed the marker image. This makes it possible to render the marker image inconspicuous by utilizing the fact that a change in color difference is indiscernible as compared with a change in brightness.

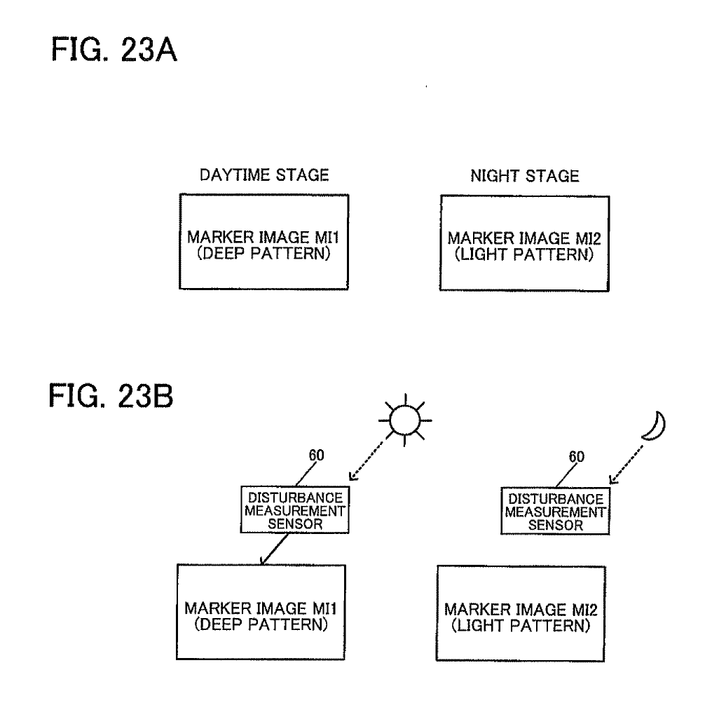

In this embodiment, the marker image may be changed corresponding to the original image. In FIGS. 23A and 23B, the marker image embedded in the original image is changed depending on whether the original image (game image) is an image in the daytime stage or an image in the night stage.

Specifically, since the brightness of the entire original image is high in the daytime stage, the marker image does not stand out even if the marker image having a deep pattern (high brightness) is embedded in the original image. Moreover, since the frequency band of the original image is shifted to the high-frequency side, the position detection accuracy can be improved by embedding the marker image having a deep pattern (high brightness) in the original image. Therefore, a marker image having a deep pattern is used in the daytime stage (see FIG. 23A).

On the other hand, since the brightness of the entire original image is low in the night stage, the marker image stands out as compared with the daytime stage when the marker image having a deep pattern (high brightness) is embedded in the original image. Moreover, since the frequency band of the original image is shifted to the low-frequency side, an appropriate position detection process can be implemented even if the marker image does not have high brightness. Therefore, a marker image having a light pattern is used in the night stage (see FIG. 23A).

Although FIG. 23A shows an example in which the marker image is changed depending on the stage type, the method according to this embodiment is not limited thereto. For example, the brightness of the entire original image in each frame may be calculated in real time, and the marker image embedded in the original image may be changed based on the calculation result. For example, a marker image having high brightness may be embedded in the original image when the entire original image has high brightness, and a marker image having low brightness may be embedded in the original image when the entire original image has low brightness. Alternatively, the marker image may be changed based on occurrence of a game event (e.g., story change event or character generation event) other than a game stage change event. A marker image having a light pattern may be linked to the original image for which the marker image stands out, and a marker image having a light pattern may be selected and embedded when such an original image is displayed.

The marker image may be changed depending on the surrounding environment of the display section 190. In FIG. 23B, the intensity of surrounding light that may serve as a disturbance to the display image is measured using a disturbance measurement sensor 60 (e.g., photosensor). The marker image is changed based on disturbance measurement information from the disturbance measurement sensor 60.

For example, when the disturbance measurement sensor 60 has detected that the time zone is daytime, and the room is bright, a marker image having a deep pattern (high brightness) is embedded in the original image. Specifically, when the room is bright, the marker image does not stand out even if the marker image has high brightness. Moreover, the position detection accuracy can be improved by increasing the brightness of the marker image based on the brightness of the room. Therefore, a marker image having high brightness is embedded in the original image.

When the disturbance measurement sensor 60 has detected that the time zone is night, and the room is dark, a marker image having a light pattern (low brightness) is embedded in the original image. Specifically, when the room is dark, the marker image stands out if the marker image has high brightness. Moreover, an appropriate position detection process can be implemented without increasing the brightness of the marker image to a large extent. Therefore, a marker image having low brightness is embedded in the original image.

According to the above method, since an optimum marker image is selected and embedded depending on the surrounding environment of the display section 190, an appropriate position detection process can be implemented.

5. Embedding of Marker Image Based on Given Condition

The marker image need not necessarily be always embedded. The marker image may be embedded (output) only when a given condition has been satisfied. Specifically, the original image in which the marker image is not embedded is output as the display image when a given condition has not been satisfied, and an image generated by embedding the marker image in the original image is output as the display image when a given condition has been satisfied.

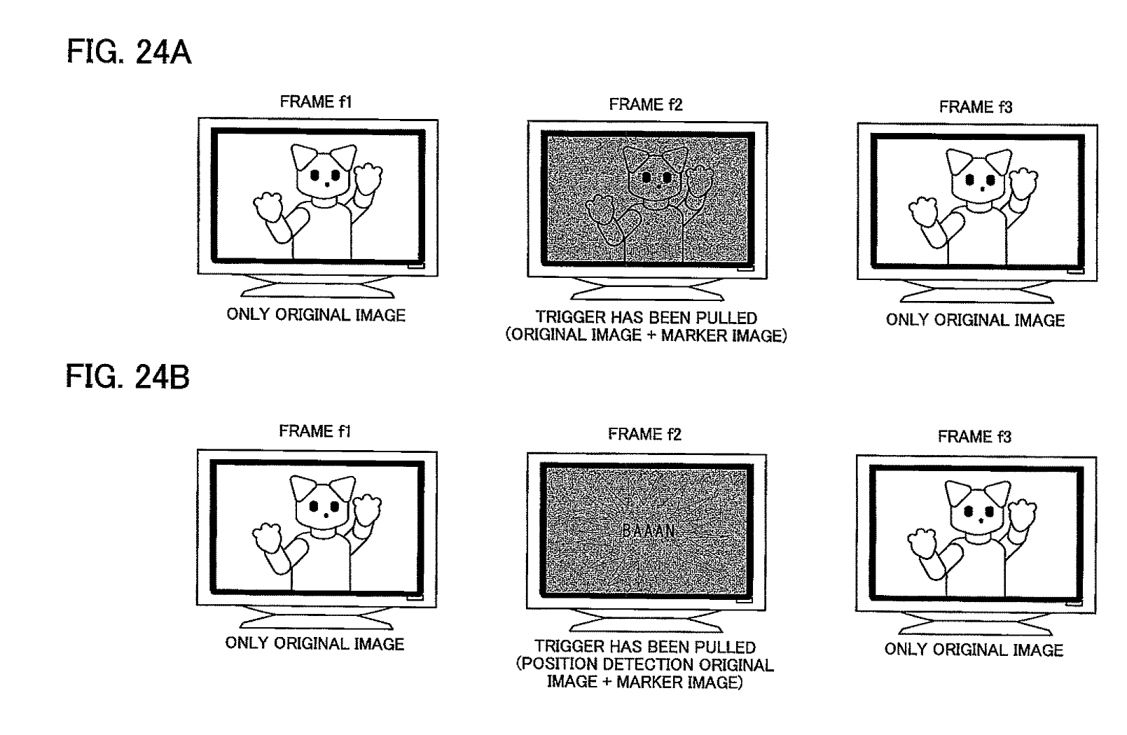

In FIG. 24A, only the original image in which the marker image is not embedded is displayed in a frame f1. It is determined that the player has pulled the trigger 34 of the gun-type controller 30 in a frame f2 subsequent to the frame f1, and an image generated by embedding the marker image in the original image is displayed. Only the original image in which the marker image is not embedded is displayed in a frame f3 subsequent to the frame C.

Specifically, an image generated by embedding the marker image in the original image is displayed only when a given condition (i.e., the player has pulled the trigger 34 of the gun-type controller 30) has been satisfied. Therefore, since an image generated by embedding the marker image in the original image is displayed only at the timing of shooting, the marker image can be rendered inconspicuous so that the quality of the display image can be improved. Specifically, since the marker image is momentarily displayed only at the timing at which the player has pulled the trigger 34, the player does not easily become aware that the marker image is embedded.

Note that the frame in which the player has pulled the trigger 34 need not necessarily be the same as the frame in which an image generated by embedding the marker image in the original image is displayed. For example, an image generated by embedding the marker image in the original image may be displayed when several frames have elapsed after the frame in which the player has pulled the trigger 34. A given condition according to this embodiment is not limited to the condition whereby the player has pulled the trigger 34 (see FIG. 23A). For example, it may be determined that a given condition has been satisfied when the player has performed an operation other than an operation of pulling the trigger 34. Specifically, an image generated by embedding the marker image in the original image may be displayed when it has been determined that a position detection timing has been reached (i.e., a given condition has been satisfied) based on instruction information from the pointing device (e.g., gun-type controller 30). For example, an image generated by embedding the marker image in the original image may be displayed when the player plays a music game and has pressed a button or the like at a timing at which a note has overlapped a line.

Alternatively, an image generated by embedding the marker image in the original image may be displayed when a given game event has occurred (i.e., a given condition has been satisfied). Examples of the given game event include a game story change event, a game stage change event, a character generation event, a target object lock-on event, an object contact event, and the like.

For example, the marker image for a shooting hit check is unnecessary before the target object (target) appears. In this case, only the original image is displayed. When a character (target object) has appeared (has been generated) (i.e., a given condition has been satisfied), an image generated by embedding the marker image in the original image is displayed so that the hit check process can be performed on the target object and the virtual bullet (shot). When the target object has disappeared from the screen, only the original image is displayed without embedding the marker image since the hit check process is unnecessary. Alternatively, only the original image may be displayed before the target object is locked on, and an image generated by embedding the marker image in the original image may be displayed when a target object lock-on event has occurred so that the hit check process can be performed on the virtual bullet and the target object.

As shown in FIG. 24B, a position detection original image (position detection image) may be displayed when a given condition has been satisfied (e.g., the player has pulled the trigger 34). In FIG. 24B, an image that shows the launch of a virtual bullet is generated as the position detection original image when the player has pulled the trigger 34, and an image generated by embedding the marker image in the position detection original image is displayed.

According to this configuration, since the player recognizes that the image generated by embedding the marker image in the position detection original image is an effect image, the marker image can be rendered more inconspicuous.

Note that the position detection original image is not limited to the image shown in FIG. 24B. For example, the position detection original image may be an effect image that is displayed in a way differing from FIG. 24B, or may be an image in which the entire screen is displayed in a given color (e.g., white).

For example, an image generated by embedding the marker image in the original image may be necessarily displayed irrespective of whether or not a given condition has been satisfied, and the pointing position PP may be determined based on an image acquired from the display image when a given condition has been satisfied. For example, an image generated by embedding the marker image in the original image may be necessarily displayed on the display section 190 shown in FIG. 17. When a given condition has been satisfied (e.g., the player has pulled the trigger 34), the position detection section 46 (or a position detection section (not shown) provided in the processing section 100) determines the pointing position PP based on an image acquired from the display image at the timing at which a given condition has been satisfied. This makes it possible to determine the pointing position PP based on an image acquired at the timing at which the player has pulled the trigger 34 of the gun-type controller 30, for example.

6. Process of Image Generation Device

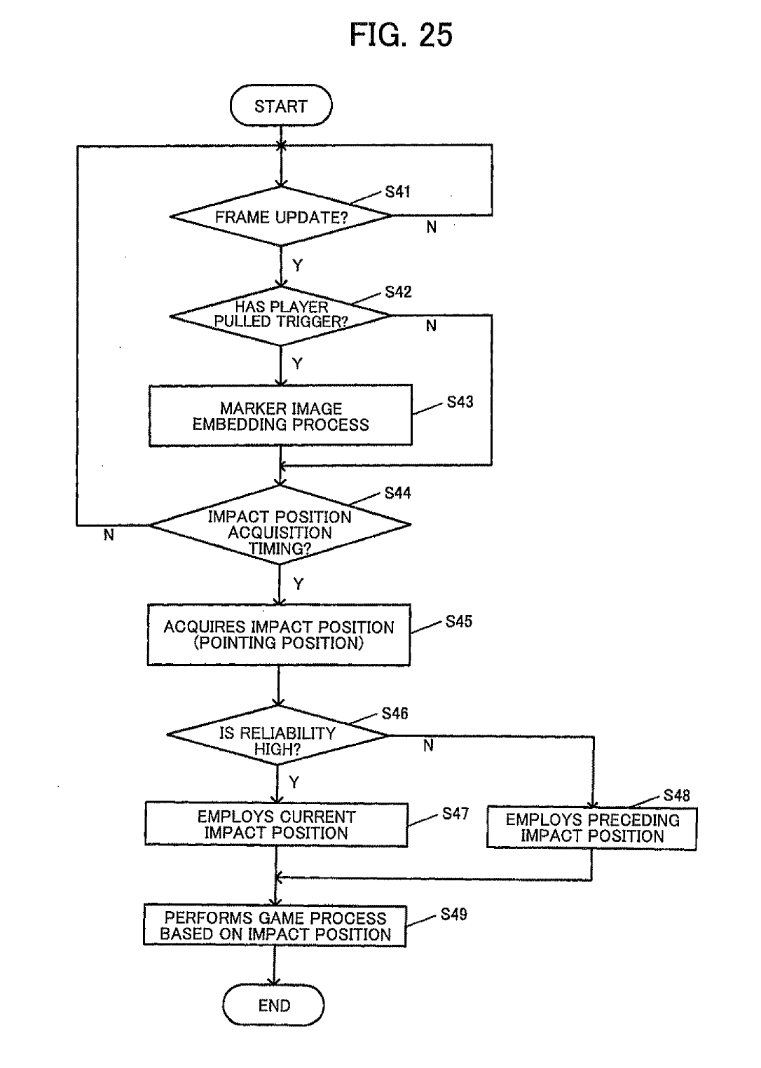

A specific processing example of the image generation device 90 according to this embodiment is described below using a flowchart shown in FIG. 25.

The image generation device 90 determines whether or not a frame ( 1/60th of a second) update timing has been reached (step S41). The image generation device 90 determines whether or not the player has pulled the trigger 34 of the gun-type controller 30 when the frame updating timing has been reached (step S42). When the player has pulled the trigger 34 of the gun-type controller 30, the image generation device 90 performs the marker image embedding process, as described with reference to FIGS. 24A and 24B (step S43).

The image generation device 90 determines whether or not an impact position (pointing position) acquisition timing has been reached (step S44). When the impact position acquisition timing has been reached, the image generation device 90 acquires the impact position from the gun-type controller 30 (step S45). The image generation device 90 determines whether or not the reliability of the impact position is high (step S46). When the reliability of the impact position is high, the image generation device 90 employs the acquired impact position (step S47). When the reliability of the impact position is low, the image generation device 90 employs the preceding impact position stored in the storage section (step S48). The image generation device 90 performs the game process (e.g., hit check process and game result calculation process) based on the employed impact position (step S49).

The invention is not limited to the above embodiments. Various modifications may be made. Any term (e.g., gun-type controller or impact position) cited with a different term (e.g., pointing device or pointing position) having a broader meaning or the same meaning at least once in the specification and the drawings can be replaced by the different term in any place in the specification and the drawings.

The pointing position detection method, the marker image embedding method, the marker image change method, and the like are not limited to those described in connection with the above embodiments. Methods equivalent to the above methods are included within the scope of the invention. The invention may be applied to various games, and may also be used in applications other than a game. The invention may be applied to various image generation devices such as an arcade game system, a consumer game system, a large-scale attraction system in which a number of players participate, a simulator, a multimedia terminal, a system board that generates a game image, and a mobile phone.

What is claimed is:

1. A position detection system that detects a pointing position, the position detection system comprising:
an image acquisition section that acquires an image from an imaging device when the imaging device has acquired an image of an imaging area corresponding to the pointing position from a display image, the display image being generated by embedding a marker image as a position detection pattern in an original image; and
a position detection section that performs a calculation process that detects the marker image embedded in the acquired image based on the acquired image to determine the pointing position corresponding to the imaging area.

2. The position detection system as defined in claim 1,
the display image being generated by converting each pixel data of the original image using each pixel data of the marker image.

3. The position detection system as defined in claim 2,
the display image being generated by converting at least one of R component data, G component data, B component data, color difference component data, and brightness component data of each pixel of the original image using each pixel data of the marker image.

4. The position detection system as defined in claim 1,
the marker image including pixel data having a unique data pattern in each segmented area of the display image.

5. The position detection system as defined in claim 1,
each pixel data of the marker image being generated by random number data using a maximal-length sequence.

6. The position detection system as defined in claim 1,
the imaging device acquiring an image of the imaging area that is smaller than a display area of the display image.

7. The position detection system as defined in claim 1,
the position detection section calculating a cross-correlation between the acquired image and the marker image, and determining the pointing position based on the cross-correlation calculation results.

8. The position detection system as defined in claim 7,
the position detection section performing a high-pass filter process on the cross-correlation calculation results or the marker image.

9. The position detection system as defined in claim 7, further comprising:
a reliability calculation section that calculates the reliability of the cross-correlation calculation results based on a maximum cross-correlation value and a distribution of cross-correlation values.

10. The position detection system as defined in claim 1, further comprising:
an image correction section that performs an image correction process on the acquired image,
the position detection section determining the pointing position based on the acquired image that has been subjected to the image correction process by the image correction section.

11. A position detection method comprising:
generating a display image by embedding a marker image as a position detection pattern in an original image, and outputting the generated display image to a display section;
detecting the marker image embedded in an image acquired from the display image based on the acquired image;
determining a pointing position corresponding to an imaging area of the acquired image; and
performing a calculation process based on the determined pointing position.

12. The position detection method as defined in claim 11, further comprising:
performing a game process including a game result calculation process based on the pointing position.

13. The position detection method as defined in claim 11, further comprising:
generating the display image by converting each pixel data of the original image using each pixel data of the marker image.

14. The position detection method as defined in claim 13, further comprising:
generating the display image by converting at least one of R component data, G component data, B component data, color difference component data, and brightness component data of each pixel of the original image using each pixel data of the marker image.

15. The position detection method as defined in claim 11,
the marker image including pixel data having a unique data pattern in each segmented area of the display image.

16. The position detection method as defined in claim 11,
each pixel data of the marker image being generated by random number data using a maximal-length sequence.

17. The position detection method as defined in claim 11, further comprising:
changing the marker image with a lapse of time.

18. The position detection method as defined in claim 11, further comprising:
calculating a cross-correlation between the acquired image and the marker image in order to determine the pointing position; and
determining the reliability of the cross-correlation calculation results, and changing the marker image based on the determined reliability.

19. The position detection method as defined in claim 11, further comprising:
changing the marker image corresponding to the original image.

20. The position detection method as defined in claim 11, further comprising:
acquiring disturbance measurement information; and
changing the marker image based on the disturbance measurement information.

21. The position detection method as defined in claim 11, further comprising:
outputting the original image in which the marker image is not embedded as the display image when a given condition has not been satisfied; and
outputting an image generated by embedding the marker image in the original image as the display image when the given condition has been satisfied.

22. The position detection method as defined in claim 21, further comprising:
generating a position detection original image as the original image when the given condition has been satisfied; and
outputting an image generated by embedding the marker image in the position detection original image as the display image.

23. The position detection method as defined in claim 21, further comprising:
outputting an image generated by embedding the marker image in the original image as the display image when it has been determined that a position detection timing has been reached based on instruction information from a pointing device.

24. The position detection method as defined in claim 21, further comprising:
performing a game process including a game result calculation process based on the pointing position; and
outputting an image generated by embedding the marker image in the original image as the display image when a given game event has occurred during the game process.

25. The position detection method as defined in claim 11, further comprising:
determining the pointing position based on the acquired image acquired from the display image when a given condition has been satisfied.

26. A computer-readable information storage medium storing a program that causes a computer to implement the position detection method as defined in claim 11.

27. An image generation device comprising:
an image generation section that generates a display image by embedding a marker image as a position detection pattern in an original image, and outputs the generated display image to a display section; and
a processing section that performs a calculation process based on a pointing position when the marker image embedded in an image acquired from the display image has been detected based on the acquired image and the pointing position corresponding to an imaging area of the acquired image has been determined.
